(19) United States
(12) Patent Application Publication
(10) Pub. No.: US 2025/0313471 A1
(43) Pub. Date: Oct. 9, 2025

(54) MECHANOCHEMICAL REDUCTION OF PHOSPHATES AS A SUSTAINABLE ROUTE TO PHOSPHITE SALTS AND ORGANOPHOSPHITE COMPOUNDS

(71) Applicant: Massachusetts Institute of Technology, Cambridge, MA (US)

(72) Inventors: Pawel Loewe, Cambridge, MA (US); Christopher C. Cummins, Dorchester, MA (US); Rachid Taakili, Boston, MA (US); Tiansi Xin (Deceased), Cambridge, MA (US)

(21) Appl. No.: 19/094,632

(22) Filed: Mar. 28, 2025

Related U.S. Application Data
(60) Provisional application No. 63/571,607, filed on Mar. 29, 2024.

(51) Int. Cl. C01B 25/16; C07F 9/141

(52) U.S. Cl. CPC C01B 25/16; C07F 9/1415

(57) ABSTRACT

Disclosed herein, among other things, are methods for the mechanochemical synthesis of phosphite salts and organophosphite compounds from phosphates, such as condensed phosphates.

### RELATED APPLICATION(S)

This application claims the benefit of U.S. Provisional Application No. 63/571,607, filed on Mar. 29, 2024. The entire teachings of the above application are incorporated herein by reference.

### BACKGROUND

Phosphorous acid (H₃PO₃) and its conjugate base, phosphite (HPO₃²⁻), have applications as reducing agents, as cathode materials for lithium- and sodium-ion batteries, as well as the starting material for other commercially important reduced phosphorus compounds, such as glyphosate. Phosphite and related H-phosphonate esters are a family of key intermediates to organophosphorus compounds via elaboration of the P—H function into P—C bonds. Recent advances in biotechnology have also cleared out a path for phosphite to act as an environmentally friendly herbicide, biostimulant, and biocide in modern agriculture owing to its minimal toxicity to humans and animals, biodegradability in soil, and inability to trigger eutrophication of natural water bodies through agricultural runoff. The development of transgenic crops that metabolize phosphite rather than phosphate has allowed phosphite to serve as both a fertilizer and herbicide.

Additionally, phosphite is thought to have been a potential major nutrient in the preoxygenated Archaen oceans, and the oxidation and condensation reactivity of inorganic phosphite likely mediated prebiotic formation of condensed phosphates. However, current production of phosphorous acid relies on a legacy process known as the thermal process, in which the phosphorus in phosphate rock is first reduced at 1500° C. to P (0) (white phosphorus, P₄), followed by oxidation back to P(III) as PCI₃ using chlorine gas. Subsequent hydrolysis provides phosphorous acid. This carbothermal legacy process is energy-intensive and involves substances that are environmentally hazardous. Removal of phosphate from waste streams is imperative to ameliorate eutrophication and to meet ever more stringent environmental standards, and the recovered phosphates constitute a valuable new input stream of this nonrenewable resource.

### SUMMARY

In some embodiments, disclosed herein is a compound that comprises PO₃³⁻ (ortho-phosphite), wherein the PO₃³⁻ is not bound to a transition metal ion.

In some embodiments, the compound consists of PO₃³⁻ (ortho-phosphite).

In other embodiments, disclosed herein is a composition comprising a compound of the present disclosure.

In other embodiments, disclosed herein is a method of a compound comprising PO₃³⁻ (ortho-phosphite), the method comprising:
a) combining a phosphate with i) a reducing agent or ii) a reducing agent and a dispersant, to produce a mixture; and
b) mechanically processing the mixture to produce the compound comprising the ortho-phosphite.

In yet other embodiments, disclosed herein is a method of making a silyl phosphite, the method comprising combining a silylating agent with a compound comprising PO₃³⁻ (ortho-phosphite) to produce the silyl phosphite.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1: Mechanochemical synthesis of the PO₃³⁻ anion.

FIG. 2: Subsequent reactivity of the crude ball milling mixture formed in reaction step 1.

FIG. 3: Reduction of trimetaphosphate with potassium using potassium iodide as a dispersant (reaction step 1) and subsequent transformation to phosphite salt and tris(trimethylsilyl)phosphite (reaction step 2). M=K or Na. Also shown is an example scheme of reaction step 1 conducted in a steel vessel, in one embodiment. Images (t=0 h and t=12 h) of reaction step 1 are also shown.

FIG. 4: ³¹P {¹H} NMR spectrum after aqueous workup of the crude ball-milling mixture.

FIG. 5: ³¹P NMR spectrum after purification of the phosphite salt.

FIG. 6A: Examples for pnictogen trioxoanions. FIG. 6B: Examples for condensed phosphates (one of the PO₃ units highlighted in blue). FIG. 6C: An example of a previous method of mechanochemical reduction of condensed phosphates (top), and an alternative synthesis of PO₃³⁻ containing salts and their reactivity (bottom). Counterions are generally omitted for clarity.

FIG. 7A: Synthesis of the PO₃³⁻ anion. FIG. 7B: Ball-milling jar charged with Na₃P₃O₉, K and KI before reaction. FIG. 7C: Ball-milling jar after reaction. FIG. 7D: Condensed phosphates and fluorophosphate used in this study. Counterions are omitted for clarity.

FIG. 8: ³¹P solid-state NMR spectra of example mechanochemical reaction mixtures (Na₃P₃O₉+K and Na₂PO₃F+K) at a temperature of 298 K under 20 kHz MAS. KI was used as a dispersant in both cases.

FIG. 9: Reactivity of PO₃³⁻ containing salts synthesized in this study. Percentage refers to isolated yield. Counterions are omitted for clarity.

FIG. 10: Isolated K/KI. Left side: 10 wt %; right side: 5 wt %.

FIG. 11: ³¹P NMR spectrum (162 MHZ, H₂O/D₂O, d1=40 s, 298 K) of the reaction mixture of Na₃P₃O₉ (1.67 mmol) with K (10.0 mmol) after 12 h. Aliquot taken: 79 mg. OP(OEt)₃ (80 mg) was added as internal standard.

FIG. 12: ³¹P NMR spectrum (162 MHZ, H₂O/D₂O, d1=40 s, 298 K) of the reaction mixture of Na₃P₃O₉ (1.67 mmol) with K (10.0 mmol) and KI (3.52 g, K/KI ratio 10% w/w) after 12 h. Aliquot taken: 385 mg. OP(OEt)₃ (80 mg) was added as internal standard.

FIG. 13: ³¹P NMR spectrum (162 MHZ, H₂O/D₂O, d1=30 s, 298 K) of the reaction mixture of Na₃P₃O₉ (1.00 mmol) with K/KI (pre-dispersed, 5% w/w, 6.00 mmol) after the given time. OP(OEt)₃ was added as internal standard.

FIG. 14: ³¹P NMR spectrum (162 MHZ, H₂O/D₂O, d1=30 s, 298 K) of the reaction mixture of Na₃P₃O₉ (1.67 mmol) with K/KI (pre-dispersed, 10% w/w, 10.0 mmol) after the given time. OP(OEt)₃ was added as internal standard.

FIG. 15: ³¹P NMR spectrum (162 MHZ, H₂O/D₂O, d1=30 s, 298 K) of the reaction mixture of (KPO₃)_{∞} (5.00 mmol “KPO₃⁻”) with K/KI (pre-dispersed, 10% w/w, 10.0 mmol) after the given time. OP(OEt)₃ was added as internal standard.

FIG. 16: ³¹P NMR spectrum (162 MHZ, H₂O/D₂O, d1=30 s, 298 K) of the reaction mixture of Na₅P₃O₁₀ (4.50 mmol) with K/KI (pre-dispersed, 10% w/w, 9.00 mmol) after 9 h at 600 rpm. OP(OEt)₃ was added as internal standard.

FIG. 17: ³¹P NMR spectrum (162 MHZ, H₂O/D₂O, d1=40 s, 298 K) of the reaction mixture of Na₂PO₃F (2.07 mmol) with K (4.14 mmol) and KI (1.46 g, K/KI ratio 10% w/w) after 12 h at 450 rpm. Aliquot taken: 385 mg. OP(OEt)₃ (80 mg) was added as internal standard.

FIG. 18: ³¹P solid-state NMR spectrum (20 kHz MAS, 202 MHZ, 298 K, d1=4 s) of the reaction mixture of Na₃P₃O₉ (1.67 mmol) with K (10.0 mmol, no dispersant) after 12 h at 450 rpm.

FIG. 19: Measurement of T₁ relaxation times. ³¹P solid-state NMR spectra (20 kHz MAS, 202 MHz, 298 K) of the reaction mixture of Na₃P₃O₉ (1.67 mmol) with K (10.0 mmol, no dispersant) after 12 h at 450 rpm. Values over the spectra represent the corresponding scan delay (d1).

FIG. 20: Comparison of different MAS rotation frequencies. ³¹P solid-state NMR spectra (202 MHZ, 298 K) of the reaction mixture of Na₃P₃O₉ (1.67 mmol) with K (10.0 mmol, no dispersant) after 12 h at 450 rpm.

FIG. 21: ³¹P solid-state NMR spectrum (20 kHz MAS, 202 MHz, 298 K, d1=4 s) of the reaction mixture of Na₃P₃O₉ (5.56 mmol) with K (33.3 mmol) and KI (11.7 g, K/KI ratio 10% w/w) after 12 h.

FIG. 22: Left side: Isolated product from the scale up experiment of the reduction of Na₃P₃O₉ with K and KI (10% w/w K/KI) (see S.6). Right side: A portion of this crude product after being exposed to air.

FIG. 23: Solid-state ³¹P NMR spectrum (20 kHz MAS, 202 MHz, 298 K, d1=4 s) of the reaction mixture of Na₃P₃O₉ (5.56 mmol) with K (33.3 mmol) and KI (11.7 g, K/KI ratio 10% w/w) after 12 h after being exposed to air.

FIG. 24: Solid-state ³¹P NMR spectrum (20 kHz MAS, 202 MHz, 298 K, d1=4 s) of the reaction mixture prepared according to the following parameters: Na₂PO₃F (298 mg, 2.07 mmol), K (162 mg, 4.14 mmol, 2 eq.), KI (1458 mg, 10% K/KI ratio), 450 rpm, 12 h.

FIG. 25: Ball-milling jar before the reaction, after filling it with the reactants.

FIG. 26: Ball-milling jar after the reaction, containing the crude product.

FIG. 27: Example isolation process of phosphite as BaHPO₃·H₂O, in one embodiment.

FIGS. 28A-F: Example procedure for isolating BaHPO₃·H₂O, in one embodiment. FIG. 28A: Crude mixture PO₃³⁻. FIG. 28B: After hydrolysis with H₂O. FIG. 28C: After adding MgCl₂ and NH₃. FIG. 28D: Mixture solution after filtration. FIG. 28E: After adding barium acetate. FIG. 28F: Dried BaHPO₃·H₂O.

FIG. 29A: ³¹P {¹H} NMR (162 MHz, d1=20 s, 298 K) after hydrolysis.

FIG. 29B: ³¹P {¹H} NMR (162 MHz, d1=20 s, 298 K) after adding MgCl₂ and NH₃.

FIG. 30: ³¹P {¹H} NMR (162 MHz, d1=20 s, 298 K) of the crude mixture, the distillation residue, and the distillate. The green numbers are the respective integrals.

FIG. 31: ¹H NMR (400 MHZ, d1=1 s, 298 K) of the distillate.

FIG. 32: ³¹P {¹H} NMR (162 MHz, d1=2 s, 298 K) in C₆D₆ of the dimethyl methyl phosphonate (DMMP) synthesis.

FIG. 33: ³¹P {¹H} NMR (162 MHZ, d1=25 s, 298 K) in C₆D₆ of the dimethyl methyl phosphonate (DMMP) synthesis after addition of Ph₃PO as the internal standard.

FIG. 34: ³¹P {¹H} NMR (162 MHz, d1=2 s, 298 K) in C₆D₆ of the dibenzyl benzyl phosphonate (DBBP) synthesis.

FIG. 35: ³¹P {¹H} NMR (162 MHz, d1=25 s, 298 K) in C₆D₆ of the dibenzyl benzyl phosphonate (DBBP) synthesis after addition of Ph₃PO as the internal standard.

### DETAILED DESCRIPTION

A description of example embodiments follows.

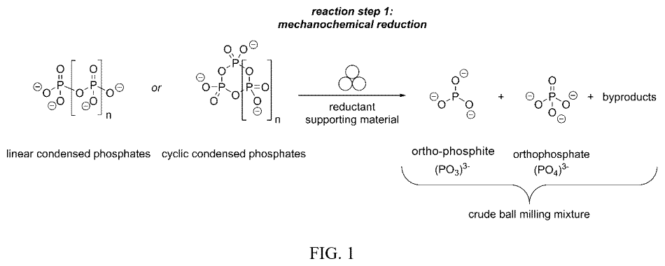

This disclosure details a novel method for the mechanochemical synthesis of phosphite compounds from phosphates (e.g., condensed phosphates) using appropriate reducing agents. Inorganic phosphite ([HPO₃]²⁻) salts and organic phosphite (P(OR)₃) compounds are important classes of phosphorus-containing chemicals and have found applications in numerous fields including battery development, drugs, materials, fertilizers and herbicides. [1] Industrially, the syntheses of both [HPO₃]²⁻ salts and P(OR)₃ compounds currently rely on phosphorus trichloride, which is manufactured exclusively from white phosphorus. [2] The current state-of-the-art industrial methods for the production of white phosphorus as well as phosphorus trichloride are energy-intensive and involve substances that are environmentally hazardous. To completely mitigate the requirement for these two substances, we have developed a new mechanochemical process in which condensed phosphates are directly reduced to the PO₃³⁻ anion, which can be regarded as the tribasic version of the well-known phosphite anion [HPO₃]²⁻ (FIG. 1). Thus, utilization of the herein disclosed mechanochemical method offers environmental advantages, including reduced energy consumption, elimination of solvents, and enhanced process sustainability.

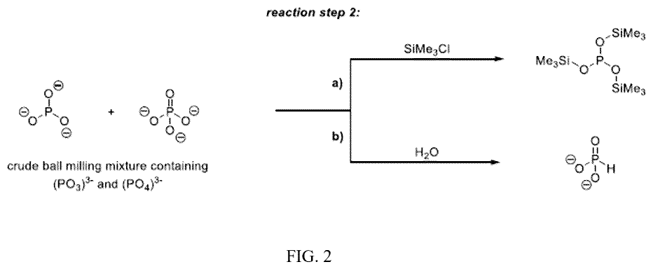

The PO₃³⁻ salt is predicted to be a useful intermediate to produce various industrially important chemicals. Therefore, we have developed subsequent procedures to convert the PO₃³⁻ containing material into either trimethylsilyl phosphite (FIG. 2A) or phosphite salts (FIG. 2B). Both these procedures are conducted at ambient conditions, mitigating the need for thermal processes.

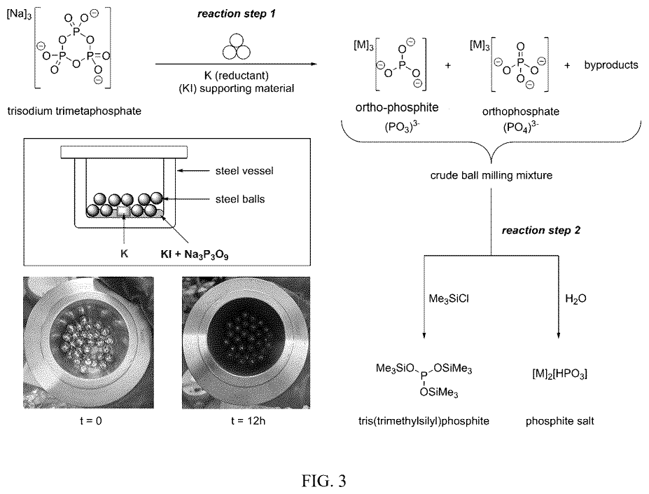

Using the disclosed method, studies have been undertaken. For example, the condensed phosphate sodium trimetaphosphate has been ball-milled with potassium as the reducing agent and potassium iodide as the supporting material (FIG. 3, reaction step 1). An example illustration of the setup is also shown in FIG. 3.

Alternatively, potassium and potassium iodide can be pre-ground in a separate step, giving a deep blue free-flowing powder. This K/KI dispersion can then be ball milled with trimetaphosphate, facilitating the precise addition of the reducing agent. Both methods (using pre-ground K/KI dispersion or directly using K and KI) give nearly the same results.

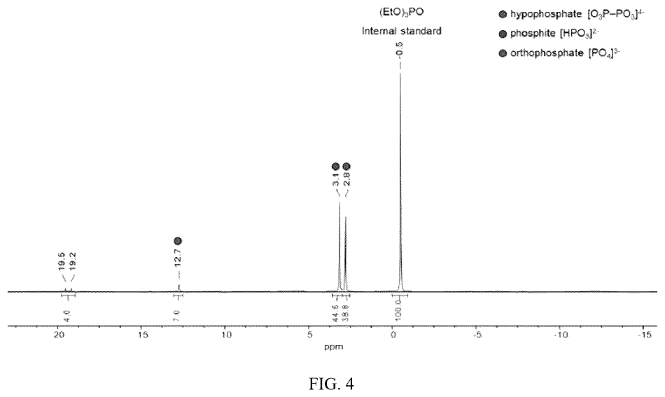

The reaction yields a black, free-flowing powder (FIG. 3, t=12 h), which consists mainly of sodium and potassium salts of PO₃³⁻ and PO₄³⁻. Addition of trimethylsilyl chloride to the crude reaction mixture (reaction step 2, left) generates the desired tris(trimethylsilyl)phosphite, which can be isolated via distillation. Aqueous workup of the crude reaction mixture (reaction step 2, right) hydrolyzes the PO₃³⁻ salts into HPO₃²⁻ salts, generating the desired phosphite species (FIG. 4).

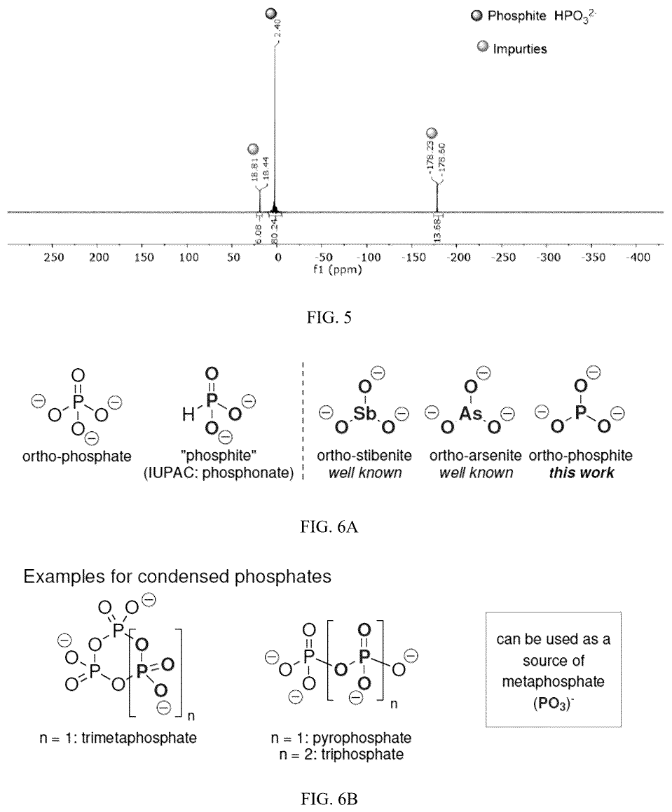

This mixture can be further purified to separate the orthophosphate, giving nearly pure phosphite (FIG. 5).

The present disclosure provides, among other things, a compound comprising PO₃³⁻ (ortho-phosphite), wherein the PO₃³⁻ is not bound to a transition metal ion. In some embodiments, the PO₃³⁻ is not bound to a metal ion. In some embodiments, a compound disclosed herein consists of PO₃³⁻ (ortho-phosphite).

In some embodiments, a compound comprises PO₃³⁻ (ortho-phosphite), wherein the PO₃³⁻ is not part of a polyoxometalate framework.

Non-limiting examples of a compound comprising PO₃³⁻ (ortho-phosphite) include Na₃PO₃, K₃PO₃ and Ca₃(PO₃)₂.

In some embodiments, a composition comprises a compound of the present disclosure (e.g., PO₃³⁻).

The present disclosure also provides, among other things, methods of making a compound comprising PO₃³⁻ (ortho-phosphite), the methods comprising:
a) combining a phosphate (e.g., a condensed phosphate, a halogenated phosphate) with i) a reducing agent or ii) a reducing agent and a dispersant, to produce a mixture; and
b) mechanically processing (e.g., ball-milling) the mixture to produce the compound.

In some embodiments, methods of making a compound comprising PO₃³⁻ (ortho-phosphite) comprise combining a phosphate (e.g., a condensed phosphate, a halogenated phosphate) with a reducing agent and/or a dispersant to produce the compound.

In some embodiments, methods of making a compound comprising PO₃³⁻ (ortho-phosphite) comprise:
a) combining a phosphate (e.g., a condensed phosphate, a halogenated phosphate) with a reducing agent and a dispersant to produce a mixture; and
b) mechanically processing (e.g., ball-milling) the mixture to produce the compound.

The present disclosure also provides, among other things, methods of making a silyl phosphite, the methods comprising combining a silylating agent with a compound comprising PO₃³⁻ (ortho-phosphite) to produce the silyl phosphite.

In some embodiments, methods of making a silyl phosphite comprise one or more of:
a) combining a phosphate (e.g., a condensed phosphate) with i) a reducing agent or ii) a reducing agent and a dispersant, to produce a mixture;
b) mechanically processing the mixture to produce a compound comprising PO₃³⁻ (ortho-phosphite); and
c) combining a silylating agent and/or a solvent with the compound to produce the silyl phosphite.

In some embodiments, methods of making a silyl phosphite comprise:
a) combining a phosphate (e.g., a condensed phosphate, a halogenated phosphate) with a reducing agent and a dispersant to produce a mixture;
b) mechanically processing the mixture to produce a compound comprising PO₃³⁻ (ortho-phosphite); and
c) combining a silylating agent and/or a solvent with the compound to produce the silyl phosphite.

The present disclosure also provides, among other things, methods of making a silyl phosphite, the methods comprising:
a) combining a phosphate (e.g., a condensed phosphate, a halogenated phosphate) with i) a reducing agent or ii) a reducing agent and a dispersant, to produce a mixture;
b) mechanically processing the mixture to produce a compound comprising PO₃³⁻ (ortho-phosphite); and
c) combining a silylating agent with the compound to produce the silyl phosphite.

The present disclosure also provides, among other things, methods of making a phosphonate comprising a hydrocarbon group (e.g., an alkyl, an aryl, etc.), the methods comprising combining an agent (e.g., an alkylating agent) and/or a solvent with a compound comprising PO₃³⁻ (ortho-phosphite) to produce the phosphonate.

In some embodiments, methods of making a phosphonate comprising a hydrocarbon group (e.g., an alkyl, an aryl, etc.) comprise:
a) combining a phosphate (e.g., a condensed phosphate) with i) a reducing agent or ii) a reducing agent and a dispersant, to produce a mixture;
b) mechanically processing the mixture to produce a compound comprising PO₃³⁻ (ortho-phosphite); and
c) combining an agent (e.g., an alkylating agent) and/or a solvent with the compound to produce the phosphonate.

In some embodiments, methods of making a phosphonate comprising a hydrocarbon group (e.g., an alkyl, an aryl, etc.) comprise:
a) combining a phosphate (e.g., a condensed phosphate) with a reducing agent and a dispersant to produce a mixture;
b) mechanically processing the mixture to produce a compound comprising PO₃³⁻ (ortho-phosphite); and
c) combining an agent (e.g., an alkylating agent) and/or a solvent with the compound to produce the phosphonate.

In some embodiments, an agent is an alkyl halide or an aryl halide. In some embodiments, an agent is methyl iodide. In some embodiments, an agent is benzyl bromide.

In some embodiments, combining an agent and/or a solvent with a compound comprising PO₃³⁻ (ortho-phosphite) to produce a phosphonate comprises heating the agent and/or the solvent with the compound (e.g., heating at from about 60° C. to about 150° C.).

In some embodiments, combining a phosphate (e.g., a condensed phosphate) with i) a reducing agent or ii) a reducing agent and a dispersant, to produce a mixture comprises adding the phosphate, the reducing agent, and/or the dispersant to a container (e.g., a ball-milling jar).

Non-limiting examples of mechanically processing a mixture include milling (e.g., ball-milling, vibratory milling), extruding, grinding, homogenization, sonication, and shear mixing, or combinations thereof.

In some embodiments, a reducing agent comprises sodium or potassium.

In some embodiments, a dispersant comprises sodium chloride or potassium iodide. In some embodiments, a dispersant comprises potassium iodide.

In some embodiments, the weight ratio of the reducing agent to the dispersant is from about 0:1 to about 1:20 (e.g., about 0:1 to about 1:19, about 1:2 to about 1:20, about 1:5 to about 1:20, about 1:5 to about 1:10, etc.). In some embodiments, the weight ratio of the reducing agent to the dispersant is about 0:1 to about 1:19. In some embodiments, the weight ratio of the reducing agent to the dispersant is about 1:9.

In some embodiments, a mixture of potassium and potassium iodide is a 10% w/w potassium and potassium iodide mixture.

In some embodiments, prior to combining a phosphate (e.g., a condensed phosphate) with a reducing agent and a dispersant (e.g., to produce a mixture), methods of the present disclosure comprise preparing a dispersion comprising the reducing agent and the dispersant (e.g., mechanically processing the reducing agent and the dispersant, such as using a mortar and pestle). In some embodiments, mechanically processing the reducing agent and the dispersant comprises ball-milling the reducing agent and the dispersant using 10 mm ball bearings (e.g., at 200 rpm for from about 10 min to about 10 h).

In some embodiments, mechanically processing a mixture to produce a compound comprising PO₃³⁻ (ortho-phosphite) is performed using ball bearings of a diameter of from about 1 mm to about 100 mm (e.g., about 1 mm to about 50 mm, about 1 mm to about 40 mm, about 1 mm to about 30 mm, about 1 mm to about 20 mm, about 5 mm to about 15 mm, etc.). In some embodiments, mechanically processing a mixture to produce a compound comprising PO₃³⁻ (ortho-phosphite) is performed using ball bearings of a diameter of about 10 mm.

In some embodiments, the ball bearings are made of a material comprising steel, carbon, zirconium, tungsten carbide, agate, alumina, nickel, or a combination thereof.

In some embodiments, mechanically processing a mixture to produce a compound comprising ortho-phosphite is performed for from about 1 hour to about 24 hours. In some embodiments, mechanically processing a mixture to produce a compound comprising ortho-phosphite is performed for about 12 hours.

In some embodiments, mechanically processing a mixture to produce a compound comprising ortho-phosphite is performed using ball-milling at a speed of from about 200 rpm to about 500 rpm.

In some embodiments, mechanically processing a mixture to produce a compound comprising ortho-phosphite is performed in a container (e.g., a steel container). In some embodiments, the container has a volume of from about 125 mL to about 1 L. In some embodiments, the container is made of a material comprising zirconium, tungsten carbide, agate, alumina, nickel, or a combination thereof.

In some embodiments, a phosphate (e.g., a condensed phosphate) comprises a linear condensed phosphate, a cyclic condensed phosphate, a halogenated phosphate (e.g., fluorophosphate), a polymeric phosphate (e.g., (KPO₃)_{∞}), or a combination thereof.

In some embodiments, a phosphate is Na₃P₃O₉, Na₅P₃O₁₀, (KPO₃)_{∞}, or Na₂PO₃F. In some embodiments, a phosphate is Na₃P₃O₉ or (KPO₃)_{∞}.

In some embodiments, combining a silylating agent with a compound comprising PO₃³⁻ (ortho-phosphite) to produce a silyl phosphite comprises adding the silylating agent to the compound to form a suspension and mixing (e.g., stirring, vigorously stirring, stirring at about 1000 rpm) the suspension (e.g., for about 1 h to about 10 h, about 5 h, etc.).

In some embodiments, combining a silylating agent and a solvent with a compound comprising PO₃³⁻ (ortho-phosphite) to produce a silyl phosphite comprises suspending the compound in the solvent to form a suspension, adding the silylating agent to the suspension, and mixing (e.g., stirring, vigorously stirring, stirring at about 1000 rpm) the suspension (e.g., for about 1 h to about 10 h, about 5 h, etc.).

In some embodiments, a solvent is an organic solvent. In some embodiments, the solvent is THF.

In some embodiments, methods of the present disclosure further comprise isolating a silyl phosphite (e.g., from a solution). In some embodiments, isolating the silyl phosphite comprises using filtration (e.g., filtration through celite), distillation (e.g., vacuum distillation), evaporation (e.g., rotary evaporation), recrystallization, extraction (e.g., liquid-liquid extraction), and chromatography (e.g., column chromatography, thin-layer chromatography), or a combination thereof. In some embodiments, isolating the silyl phosphite comprises using filtration and vacuum distillation. In some embodiments, isolating the silyl phosphite comprises using vacuum distillation.

In some embodiments, a silylating agent is a silyl halide, trialkoxysilane, silyl ester, silyl isocyanate, silyl nitrile, silyl sulfonate, or silyl phosphate. In some embodiments, a silylating agent is a silyl halide, trialkoxysilane, or silyl ester. In some embodiments, a silylating agent is a silyl halide. In some embodiments, a silylating agent is trimethylsilyl chloride.

In some embodiments, a silyl phosphite is tris(trimethylsilyl)phosphite (TTSP).

In some embodiments, methods of the present disclosure further comprise isolating a phosphonate (e.g., from a solution). In some embodiments, isolating the phosphonate comprises using filtration (e.g., filtration through celite), distillation (e.g., vacuum distillation), evaporation (e.g., rotary evaporation), recrystallization, extraction (e.g., liquid-liquid extraction), and chromatography (e.g., column chromatography, thin-layer chromatography), or a combination thereof. In some embodiments, isolating the phosphonate comprises using filtration and vacuum distillation. In some embodiments, isolating the phosphonate comprises using vacuum distillation.

It should be understood that the subject matter defined in the appended claims is not necessarily limited to the specific implementations described above. The specific implementations described above are disclosed as examples only.

### Definitions

It is to be understood that the terminology used herein is for describing particular embodiments only and is not intended to be limiting. Unless defined otherwise, all technical and scientific terms used herein have the same meaning as commonly understood by one of ordinary skill in the art to which the disclosure pertains.

Although any methods and devices similar or equivalent to those described herein may be used in the practice for testing of the present disclosure, example devices and methods are described herein.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

As used in this specification and the appended claims, the singular forms “a,” “an,” and “the” include plural referents unless the content clearly dictates otherwise. The conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Unless the context requires otherwise, throughout the specification and claims that follow, the word “comprise” and synonyms and variants thereof such as “have” and “include”, as well as variations thereof, such as “comprises” and “comprising”, are to be construed in an open, inclusive sense, e.g., “including, but not limited to.” The transitional terms “comprising,” “consisting essentially of,” and “consisting of” are intended to connote their generally accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element or step not specified in the claim; and (iii) “consisting essentially of” limits the scope of a claim to the specified materials or steps “and those that do not materially affect the basic and novel characteristic(s)” of the claimed invention and disclosure. Embodiments described in terms of the phrase “comprising” (or its equivalents) also provide as embodiments those independently described in terms of “consisting of” and “consisting essentially of.”

“About” means within an acceptable error range for the particular value as determined by one of ordinary skill in the art, which will depend in part on how the value is measured or determined, i.e., the limitations of the measurement system. Unless explicitly stated otherwise within the disclosure, claims, result or embodiment, “about” means within one standard deviation per the practice in the art, or can mean a range of ±20%, ±10%, ±5%, ±4, ±3, ±2 or ±1% of a given value. It is to be understood that the term “about” can precede any particular value specified herein, except for particular values used in the Examples.

All percents are intended to be weight percent unless otherwise specified. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

### EXAMPLES

### Example 1

Phosphorus is an indispensable element for life, playing a key role in all living organisms. [3,4] The most important form of phosphorus in nature and life are phosphorus oxoanions, especially phosphates. They are essential components of DNA and RNA, forming their backbone, and also play a crucial role in cell membranes, providing structural support and facilitating important cellular processes like signaling and transport. [5] Additionally, adenosine triphosphate (ATP) has a key role in providing energy for biochemical reactions within cells. [6,7]

Despite the ubiquity, biological importance, and economic relevance of phosphorus oxoanions such as PO₄³⁻ (ortho-phosphate) and HPO₃²⁻ (IUPAC name: phosphonate, commonly called “phosphite”), [8,9] the literature lacks documentation of PO₃³⁻ (herein referred to as “orthophosphite”). To the best of our knowledge, characterization of the PO₃³⁻ fragment is hitherto limited to polyoxometalate systems, such as polyoxomolybdate species, that are templated around a central P^{III}O₃ moiety. [10,11] The absence of “free” ortho-phosphite in the literature stands in stark contrast to the situation for corresponding heavier EO₃³⁻ (E=pnictogen element) trioxoanions such as ortho-arsenite (AsO₃³⁻) and ortho-antimonite (SbO₃³⁻), which are well documented, [12-14] with some examples even occurring in nature (e.g, Reinerite (Zn₃ (AsO₃)₂)).

Ortho-phosphite can therefore be construed as a “missing” oxoanion in this series, both regarding the family of phosphorus oxoanions and the heavier EO₃³⁻ analogues. This absence is particularly striking given the ubiquity of other phosphorus oxoanions, such as PO₄³⁻ and HPO₃²⁻. Another key relevance of phosphorus oxoanions is their importance in many industrial fields, ranging from fertilizers to flame retardants. [16,17] Phosphorus compounds generally originate from industrially mined phosphate salts. [18] However, the legacy process of turning phosphates into reduced phosphorus compounds relies on the production of white phosphorus: a process, which is both energy intensive and environmentally hazardous. [19,20] Recently, we have turned our attention towards finding synthetic pathways to omit white phosphorus as an intermediate in phosphorus processing. [21-26] For example, we reported on the synthesis of tetrabutylammonium bis(trichlorosilyl)phosphide ([TBA][P(SiCl₃)₂]), which we directly prepared from various phosphate sources and trichlorosilane. [21-23] Studies reported by Quan and co-workers as well as demonstrate that this phosphide salt can be used as a precursor or a multitude of phosphorus compounds traditionally made from white phosphorus. [21-23,27-30] These insights motivated us to pursue the synthesis of a PO₃³⁻ salt not only from a fundamental standpoint, but also as a useful synthetic intermediate, which could possibly allow for a more atom-economical synthesis of commercially interesting organophosphorus compounds.

Herein, we report the first synthesis and characterization of ortho-phosphite (PO₃³⁻) via the mechanochemical reduction of condensed phosphates. Solid-state NMR and subsequent reactivity studies confirm its identity and demonstrate its potential as a precursor to industrially relevant organophosphorus compounds. This discovery not only addresses the gap in phosphorus oxoanions but also provides a greener pathway for phosphorus chemistry, circumventing the need for white phosphorus-based processes.

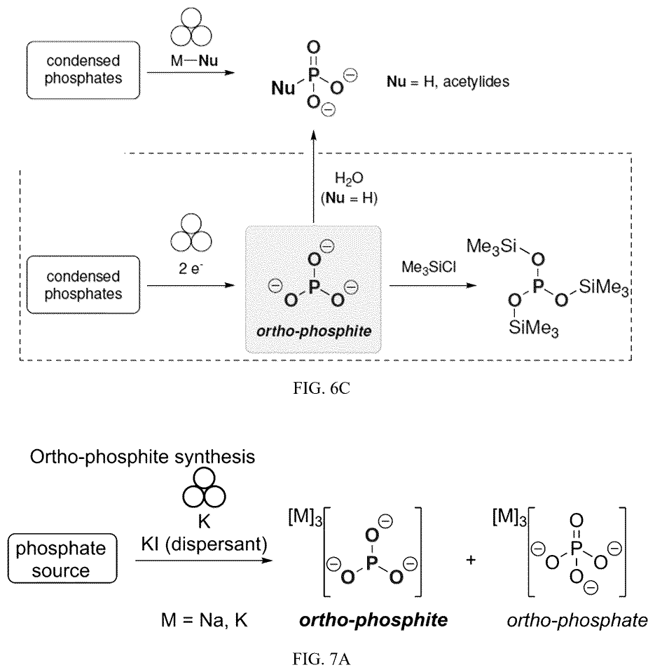

Recently, we have explored mechanochemical reactions involving condensed phosphates, which can act as a metaphosphate (PO₃) source (FIG. 6B). Ball-milling these phosphates with metal hydrides resulted in the formation of phosphite (HPO₃²⁻) in a single step (FIG. 6C). [24,25] Very recently, we have expanded the scope of nucleophiles to acetylides and carbides, which we used to synthesize a range of alkynyl phosphonates. [26] Targeting to develop a synthetic access to PO₃³⁻, our next aim was to reduce condensed phosphates without nucleophilic attack. The envisaged reduction is given in equation 1.

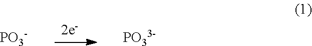

Therefore, we started by investigating the mechanochemical reaction between condensed phosphates and common reducing agents. In 2018, Jones and coworkers demonstrated that potassium dispersed on potassium iodide (K/KI) is a suitable reductant for the synthesis of magnesium (I) compounds. [31] In the following years, the groups of Jones, Evans, and Harder established K/KI as a versatile reducing agent for a range of different low-valent systems. [32-37] Most notably, Harder and co-workers reported that K/KI can be used as a reductant in mechanochemical synthesis. [35-37] Therefore, we decided that this might be a suitable reagent for the mechanochemical reduction of condensed phosphates. To be able to conduct the full synthetic protocol in mechanochemical conditions, we deviated from the standard procedure of K/KI preparation by heating/stirring the mixture under reduced pressure, [31] and used a ball mill instead (see S.2 for details). Ball-milling potassium chunks with pre-ground KI resulted in formation of a fine, free-flowing deep blue powder, similar to the one previously reported in the literature. [31] Additionally to the 5% w/w K/KI reported in the literature, we were able to prepare a more concentrated 10% w/w K/KI dispersion as well. Preparation of a 15% w/w K/KI dispersion was attempted, but was unsuccessful due to severe caking of the material.

Next, we focused our attention on choosing a suitable “PO₃⁻” source. Trimetaphosphate (P₃O₉³⁻) is the smallest cyclic phosphate with an O:P ratio of 3. Therefore, it is an attractive starting material, suggesting ideally an atom-economical reduction to PO₃³⁻. In contrast, linear condensed phosphates with the general formula PₙO₃ₙ₊₁⁽ⁿ⁺²⁾⁻ have a larger O:P ratio and inherently produce some amount of PO₄³⁻.

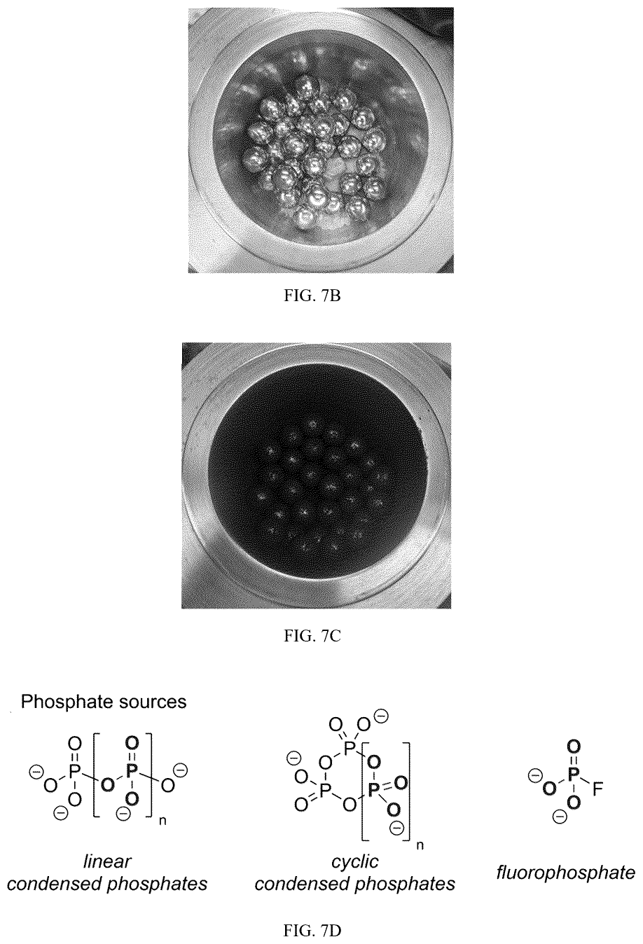

Mechanochemical reactions were conducted in a planetary ball mill using 125 mL stainless steel jars and 30 ball bearings (Ø 10 mm). All cases resulted in the formation of a black, free-flowing powder (see FIG. 7B), which immediately turns white when exposed to air. The crude mixtures are completely insoluble in aprotic organic solvents such as tetrahydrofuran, diethyl ether, diglyme, tetramethylethylenediamine or trimethyl phosphate, whereas protic solvents such as methanol or water result in a vigorous reaction and rapid discoloration. Hence, liquid-state NMR analysis of the crude reduction products is limited to the hydrolysis products. ³¹P NMR analysis of aqueous solutions revealed PO₄³⁻ and HPO₃²⁻ as the major products in all cases, of which the latter is rationalized by hydrolysis of PO₃³⁻ (see FIG. 7A). Hence, PO₃³⁻ yield was determined by quantification of HPO₃²⁻ via ³¹P NMR spectroscopy (see S.3.2 for more information).

The effect of the dispersant was investigated for the reduction of trisodium trimetaphosphate (Na₃P₃O₉, see Table 1). The K: KI ratio of the K/KI dispersion seems to not significantly affect yield. Moreover, we found that instead of a pre-dispersed K/KI mixture, K and KI can be added directly to the reaction vessel without significant yield diminishment (see FIG. 7B for a typical reaction setup). Complete omission of a dispersant gave satisfactory results in many cases, but occasional caking of the potassium metal inside the ball-milling jar led to reproducibility issues. Other tested dispersants such as silica and graphite did not give any significant amounts of product. Hence, employment of KI as a dispersant in a 10% w/w K/KI ratio was deemed to be optimal.

TABLE 1
Scope of Phosphate Sources and Effects of Dispersant Loading.^{a}

| | | | PO₃³⁻ | |
|---|---|---|---|---|
| phosphate | | K/KI | yield | recovery |
| source | eq. K | (w/w %) | (%)^{b} | (%)^{b} |
| Na₃P₃O₉ | 6 | no KI | 30 | 87 |
| Na₃P₃O₉ | 6 | 5 | 39 | 81 |
| Na₃P₃O₉ | 6 | 10 | 32 | 82 |
| Na₃P₃O₉^{c} | 6 | 10 | 45 | 89 |
| Na₅P₃O₁₀^{d} | 2 | 10 | 5[14]^{f} | 92 |
| (KPO₃)_{∞} | 2 | 10 | 25 | 84 |
| (KPO₃)_{∞}^{e} | 2 | 10 | 41 | 83 |
| Na₂PO₃F^{c} | 2 | 10 | 44 | 90 |

^{a}Reaction conditions: 450 rpm, 12 h.
^{b}Determined from HPO₃²⁻ yield after hydrolysis by quantitative ³¹P NMR (see S.3.2 for details).
^{c}K and KI not pre-dispersed.
^{d}600 rpm, 9 h.
^{e}24 h.
^{f}The bracketed value of yield is based on one reactive PO₃ unit per molecule.

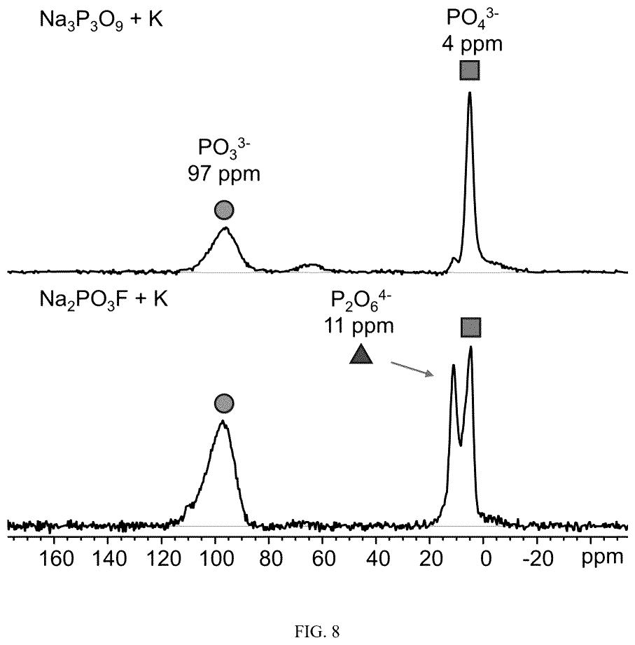

Regarding the scope of the condensed phosphates, Na₃P₃O₉ and polymeric metaphosphate (KPO₃)_{∞} gave the best results, as expected because of the ideal O:P ratio of exactly 3 for Na₃P₃O₉ and approximately 3 for (KPO₃)_{∞}. The latter species, also called “Kurrol's salt”, is a high-molecular form of potassium polyphosphate, which is generally produced by heating KH₂PO₄ at 350-500° C. in a rotary kiln. [38,39] In contrast triphosphate (P₃O₁₀⁵⁻) salt gave considerably diminished yields, even after taking into account stoichiometric P₂O₅⁴⁻ generation. Significant PO₄³⁻ generation was observed for all phosphate precursors, even the ones with the ideal O:P ratio. Besides the main species PO₃³⁻ and PO₄³⁻, small amounts of the byproducts [O₃P—PO_{3] 4} (hypophosphate) and [O₃P—PH₂]²⁻ were detected and assigned via ³¹P NMR data, [40,41] indicating the presence of possible competing reduction pathways. [24] In addition to condensed phosphates, Na₂PO₃F was investigated as an alternative phosphate precursor and gave a satisfactory result, albeit with significant hypophosphate formation (16% NMR yield). After finding the best reaction conditions, the reduction of Na₃P₃O₉ with a 10% w/w K and KI mixture was scaled up to a 500 mL stainless steel jar and 100 ball bearings (Ø 10 mm), allowing us to produce 11.1 g of the crude mixture in one run (see S.6 for details). Spectroscopic evidence of the novel PO₃³⁻ species was obtained by solid-state ³¹P NMR analysis of the crude mixtures, showing a resonance at 97 ppm (see FIG. 8), which is in the range of organophosphite (P(OR)₃) species (for example P(OPh)₃: 129 ppm, [42] P(OSiMe₃)₃: 113 ppm [43]). The signal vanishes when the sample is exposed to ambient air, highlighting the high reactivity of this species (see S.5 for more information).

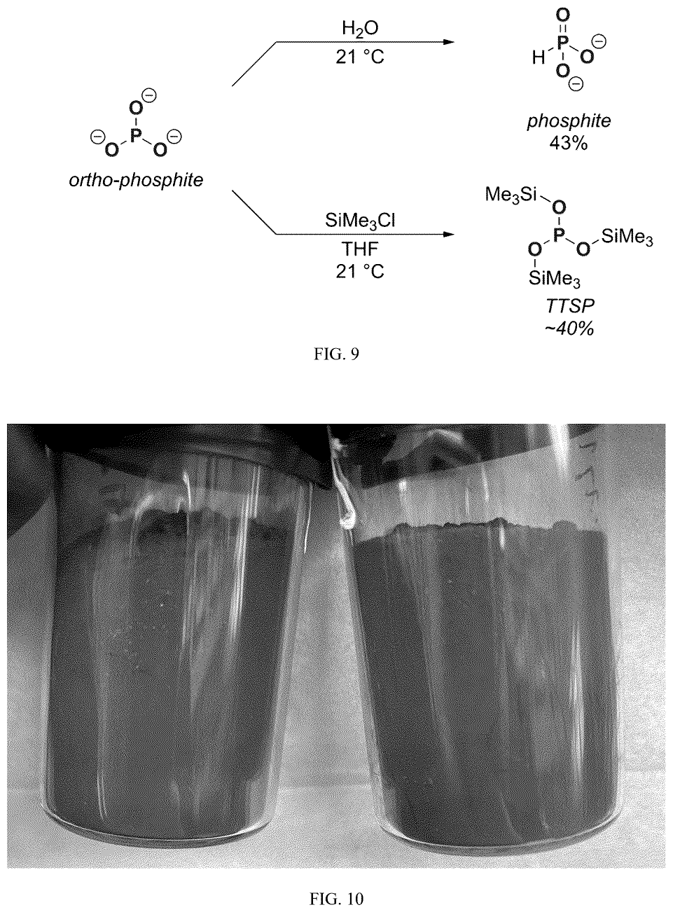

With alkali metal salts of the PO₃³⁻ species in hand, we were eager to explore their reactivity, especially as precursors to organophosphorus compounds. Since the solubility properties of the crude ball-milling mixture precluded any purification, we resorted to using the mixture directly in subsequent reactions (see FIG. 9). First, we sought to utilize our discovery that hydrolysis of PO₃³⁻ seems to quantitatively generate HPO₃²⁻. Traditionally synthesized from PCl₃, [38] this compound is used in battery materials [44-46] and in agriculture as fertilizer and fungicide. [9,47,48] Therefore, we focused on isolating this phosphite generated in our synthesis. Its separation from phosphates in the crude mixture was accomplished by precipitating ortho-phosphate as struvite (NH₄MgPO₄·6H₂O), taking advantage of this mineral's low solubility. This process yielded phosphite in a 43% isolated yield which was recovered as barium phosphite (BaHPO₃·H₂O), as described in detail in S.7.1.

Treatment of the crude PO₃³⁻ containing material with trimethylsilyl chloride resulted in formation of tris(trimethylsilyl)phosphite (TTSP), which was isolated by vacuum distillation. TTSP is a precursor used in the synthesis of phosphonates via the Michaelis-Arbuzov reaction, [49] and thus is an attractive starting material for organophosphorus compounds. Moreover, it is used as a ligand in transition metal catalysis [50] and as a battery electrolyte. [51] Preliminary studies on the alkylation of the crude PO₃³⁻ containing material with alkyl halides indicate the formation of the corresponding alkyl phosphonates (see S.8 for more information).

Conclusion: We found synthetic access to the so-far overlooked phosphorus oxoanion “ortho-phosphite” PO₃³⁻ by mechanochemical reduction of condensed phosphates. Evidence for the formation of this species was achieved by solid-state ³¹P NMR and its characteristic subsequent reactivity. Ortho-phosphite is not only interesting from a fundamental chemistry perspective, as we found that it can be used for the synthesis of industrially relevant chemicals, such as phosphite salts, TTSP or DMMP, all traditionally synthesized from white phosphorus. As mechanochemistry is on the rise in industrial chemistry, [52-55] we look forward to continue developing the synthesis of ortho-phosphite as an attractive alternative to the production of white phosphorus en route to valuable organophosphorus compounds. Additionally, further reactivity studies on this novel species are ongoing in our laboratories.

### S.1 General Information

Except as otherwise noted, all manipulations were performed in a Vacuum Atmospheres model MO-40M glovebox under an inert atmosphere of purified N₂. All solvents were obtained anhydrous and oxygen-free by bubble degassing (Ar), purified by passage through columns of alumina using a solvent purification system (Pure Process Technology, Nashua, NH), and stored over 4 Å molecular sieves. [57] Deuterated solvents were degassed and stored over 4 Å molecular sieves for at least 48 h prior to use (except D₂O). Charcoal, Celite (EM Science), and 4 Å molecular sieves were dried by heating above 200° C. under dynamic vacuum for at least 48 h prior to use. All glassware was dried in an oven for at least two hours at temperatures greater than 120° C.

Sodium trimetaphosphate (Na₃P₃O₉, ≥98%, Sigma-Aldrich), sodium fluorophosphate (Na₂PO₃F, 95%, Sigma-Aldrich), sodium triphosphate (Na₅P₃O₁₀, ≥98%, Sigma-Aldrich), potassium pyrophosphate (K₄P₂O₇, ≥97%, Sigma-Aldrich), potassium metaphosphate ((KPO₃)_{∞}, 98%, Strem Chemicals), silica (40-60 μm, 60 Å, VWR) and graphite flakes (natural, −10 mesh, 99.9% metals basis, Thermo Scientific) were dried under dynamic vacuum at at least 200° C. for at least 24 h and stored in the glovebox. Potassium was obtained as chunks in mineral oil (97%, Thermo Scientific). These chunks were cut into smaller pieces, brought into the glovebox, washed with pentane or hexane, and then stored until use. Liquid reactants were obtained from common commercial sources and dried over 4 Å molecular sieves (except trimethylsilyl chloride) and stored in the glovebox. All other reactants were obtained from common commercial sources and used as is.

Liquid-state NMR spectra were obtained on a Bruker Avance-III HD Nanobay spectrometer operating at 400.09 MHz equipped with a 5 mm liquid-nitrogen cooled Prodigy broad band observe cryoprobe. Solid-state NMR spectra were obtained on a Bruker Avance Neo spectrometer operating at 500.18 MHz equipped with a 3.2 mm HX solids probe. ¹H and ¹³C NMR spectra were referenced internally to residual solvent signals. [58] ³¹P NMR spectra were externally referenced to 85% H₃PO₄ (0 ppm).

Mechanochemical reactions were performed in a 125 mL stainless steel milling jar (Retsch, part number: 01.462.0148) equipped with a safety closure device (Retsch, part number: 22.867.0007) or a 500 mL stainless steel milling jar (Retsch, part number: 01.462.0520) equipped with a safety closure device (Retsch, part number: 22.867.0012). The jars were filled with 10 mm stainless steel balls (125 mL jar: 30 balls; 500 mL jar: 100 balls). Retsch PM 100 planetary ball mill was used for milling (Retsch, part number 20.540.0001).

### S.2 Preparation of the K/KI Dispersions

Potassium iodide was ground using mortar and pestle, and dried at 250° C. under dynamic vacuum overnight. The K/KI was titrated prior to use. Titration procedure: About 300 mg of the solid was weighed accurately and quenched with 1 ml of dry methanol. The resulting suspension was brought out and dissolved in 9 ml of water. The solution was titrated with HCl solution of known concentration to neutral pH. This procedure was repeated twice and the potassium weight percent was calculated.

10 wt %: In the glovebox, the 125 mL milling jar was charged with potassium iodide (20 g), potassium metal (2.22 g, freshly cut into small pieces) and thirty 10 mm balls. The jar was sealed properly and brought out. The mixture was ball milled at 200 rpm for 5 h (cooling break for 30 min every 30 min) and brought back in. The jar was opened in the glovebox. Severe aggregation of the solid (aka. caking) was observed. The aggregated solid was pulverized with a spatula, and another portion of potassium iodide (18.8 g) was added. The jar was sealed again, brought out and ball milled at 400 rpm for 25 min. The jar was brought in and opened. The aggregated solid was pulverized with a spatula, and another portion of potassium metal (2.00 g, freshly cut into small pieces) was added. The jar was sealed again, brought out and ball milled at 200 rpm for 10 h (cooling break for 1 h every 2 h). The jar was brought in and opened. The aggregated solid was pulverized with a spatula. The jar was sealed again, brought out and ball milled at 200 rpm for 15 min. The jar was brought in and opened. There was finally no aggregated solid. the blue powder was transferred to a vial (see FIG. 10). Titration result: 9.8 (±0.1) wt %.

5 wt %: In the glovebox, the milling jar was charged KI (20.3 g), K metal (1.07 g, freshly cut into small pieces) and thirty 10 mm balls. The jar was sealed properly and brought out. The mixture was ball milled at 200 rpm for 10 min then 400 rpm for 10 min and brought back in. The jar was opened in the glovebox. The aggregated solid was pulverized with a spatula, and the jar was sealed again, brought out and ball milled at 200 rpm for 10 min. The jar was brought in and opened. The blue powder was transferred to a vial (see FIG. 10). Titration result: 5.0 (±0.1) wt %.

S.3 General Procedure for the Synthesis of PO₃³⁻ Salts

### S.3.1 General Synthetic Procedure

Inside the glovebox, the condensed phosphate, the reducing agent, the dispersant and thirty stainless steel balls (Ø 10 mm) were added into a 125 mL ball-milling jar. The jar was sealed properly and brought out. The mixture was ball milled at the set speed and duration. When the desired milling time was reached, the jar was brought into the glovebox and opened. The reaction mixture was isolated in a vial. (Warning: The obtained crude mixture is pyrophoric. Extreme caution and proper protecting equipment is advised.)

### S.3.2 General Procedure for Determining the Yield

To determine the amount of PO₃³⁻ generated, the crude mixture was hydrolyzed: A portion of the crude mixture was transferred into another vial, brought out and cooled in an ice bath. Deionized water (ca. 5 ml) was carefully added to the material. (Warning: The reaction may be vigorous. Traces of phosphine gas may form during the hydrolysis. Proper protecting equipment and working inside of a fume hood is strictly required.) 250 mg NaHCO₃ was added to neutralize the solution. Then, a known amount of OP(OEt)₃ was added as an internal standard. The solution was analyzed by ³¹P NMR. The amount of hydrolysis product HPO₃²⁻ was determined to calculate the yield of PO₃³⁻.

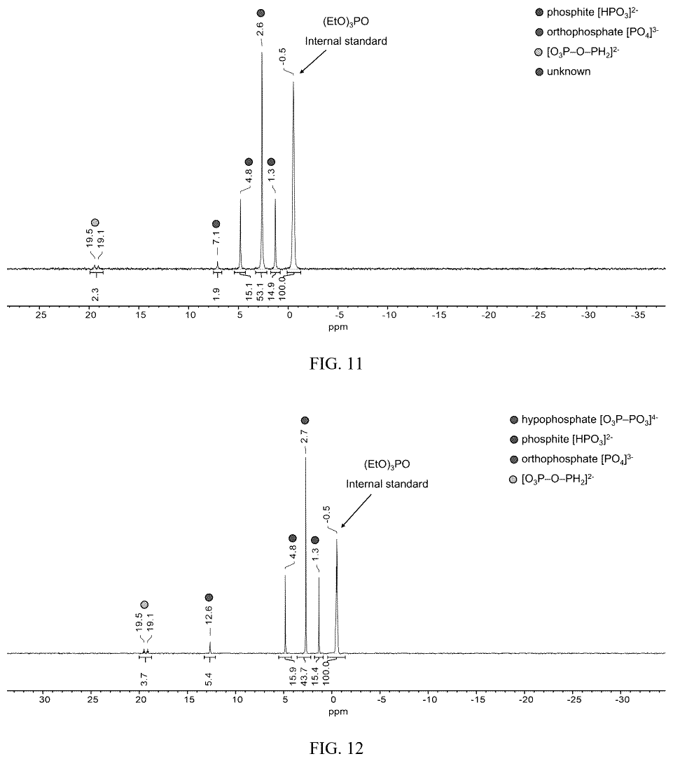

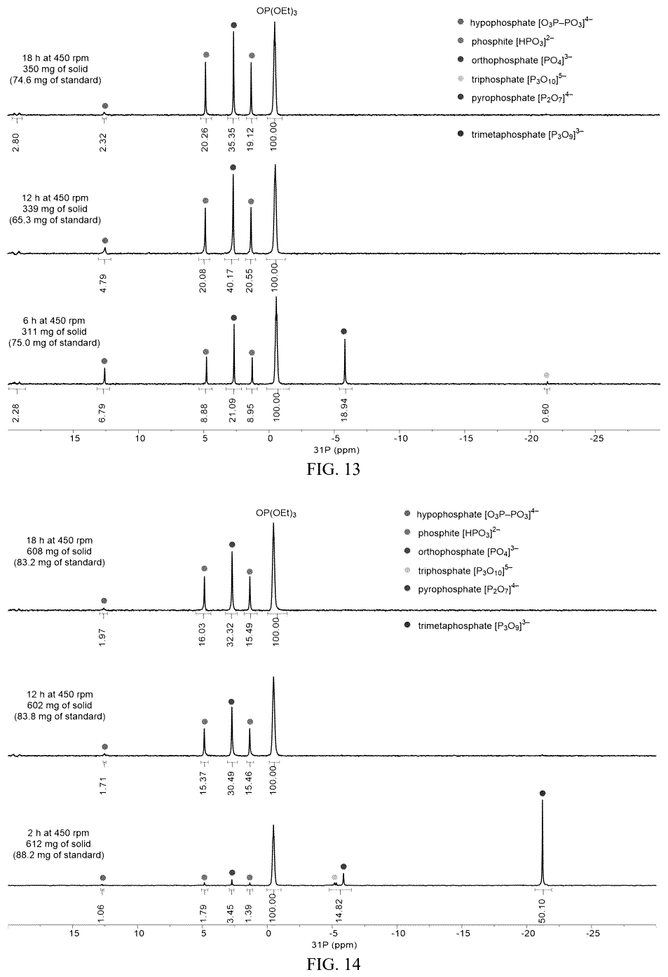

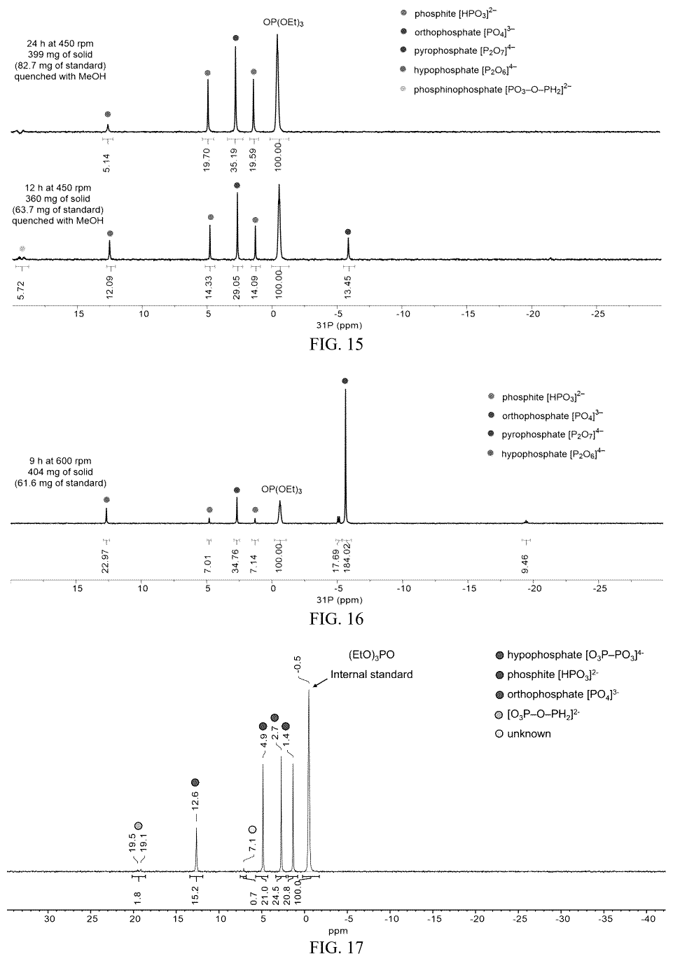

See FIGS. 11-17 for ³¹P NMR spectra.

### S.3.3 Example Procedure: Optimized Reaction Conditions

Inside the glovebox, Na₃P₃O₉ (511 mg, 1.57 mmol, 1.00 eq.), potassium (391 mg, 10.0 mmol, 6.00 eq., freshly cut single chunk), KI (1.56 g), and thirty stainless steel balls (Ø 10 mm) were added into a 125 mL ball-milling jar. The jar was sealed properly and brought out. The mixture was ball milled at 200 rpm for 5 min, then 450 rpm for 12 h (with cooling breaks of 30 min every 1 h and direction change every cycle, total process time 24 h.). When the desired grinding time was reached, the jar was brought into the glovebox and opened. The reaction mixture was isolated in a vial.

### S.4 Reaction Screening

### S.4.1 Dispersant Screening

For the screening, the general procedure described in subsection S.3 was followed with the following parameters:
Phosphate: Na₃P₃O₉ (511 mg, 1.57 mmol, 1.00 eq.)
Reducing agent: potassium (391 mg, 10.0 mmol, 6.00 eq., freshly cut single chunk)
Milling cycles: 200 rpm for 5 min, then 450 rpm for 12 h (with cooling breaks of 30 min every 1 h and direction change every cycle, total process time 24 h.)

TABLE S.1
Dispersant screening scope.

| | reductant/dispersant | |
|---|---|---|
| dispersant | (w/w %) | yield PO₃³⁻ (%) |
| none | — | 41 |
| potassium iodide^{a} | 5 | 39 |
| potassium iodide^{a} | 10 | 39 |
| silica | 10 | none |
| graphite^{a} | 10 | traces |

^{a}Reductant and dispersant were pre-dispersed in a separate step.

### S.5 ³¹P Solid-state NMR Analyses of the Crude Ball-milling Mixtures

S.5.1 Reduction of Na₃P₃O₉ with K (Without Dispersant)

The reaction was performed according to the optimized procedure (see S.3.3), just without dispersant. The crude mixture was filled into a 3.2 mm ZrO₂ MAS rotor inside of a glovebox, and then brought out for the solid-state NMR measurements.

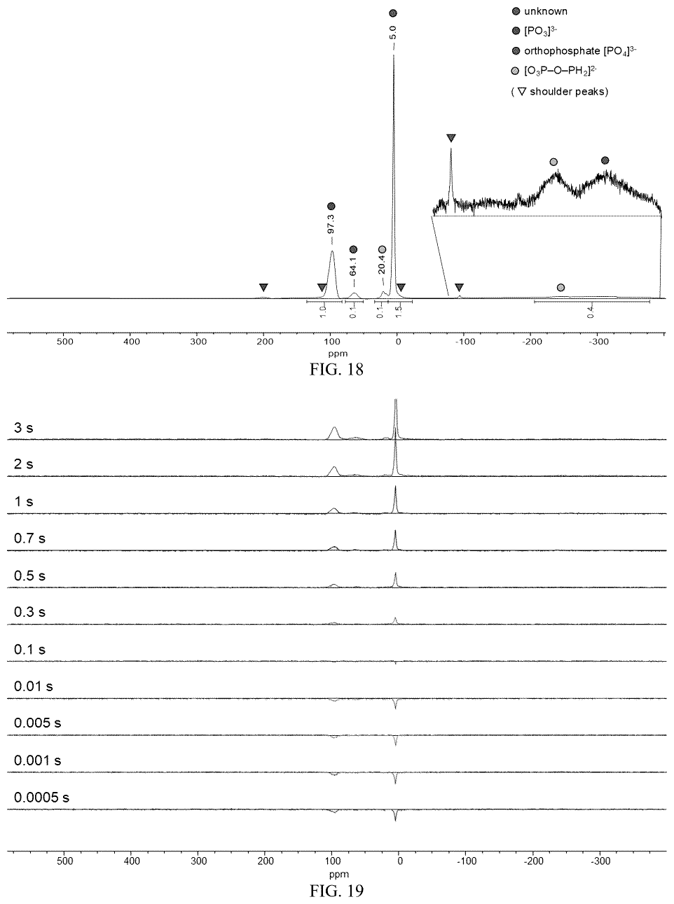

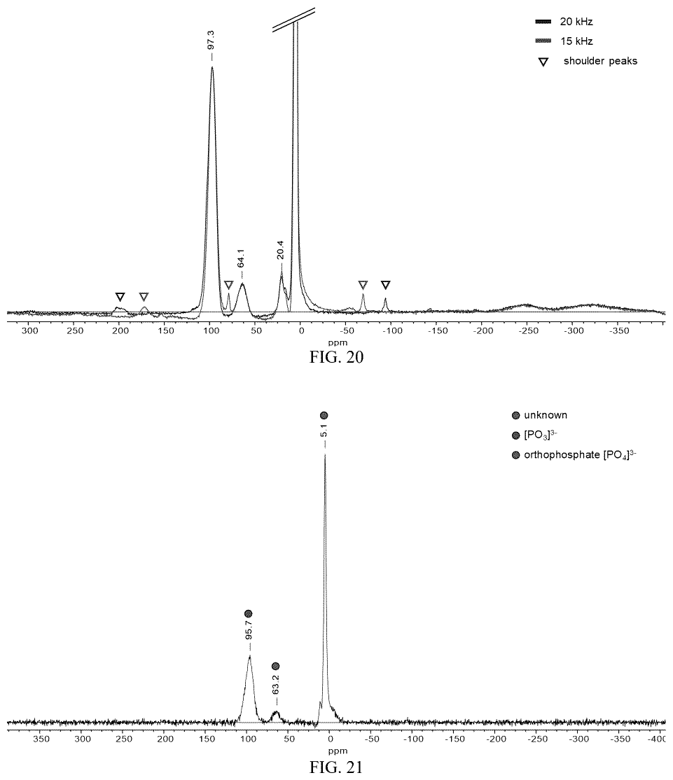

See FIG. 18 for ³¹P solid-state NMR spectrum. See FIG. 19 for measurement of T₁ relaxation times. See FIG. 20 for comparison of different MAS rotation frequencies.

S.5.2 Reduction of Na₃P₃O₉ with K and KI

The reaction was performed according to the scale-up experiment of the reduction of Na₃P₃O₉ with K and KI (10% w/w K/KI) (see S.6). The crude mixture was filled into a 3.2 mm ZrO₂ MAS rotor inside of a glovebox, and then brought out for the NMR measurements.

See FIG. 21 for ³¹P solid-state NMR spectrum.

S.5.3 Exposing PO₃³⁻ Containing Crude Material to Air

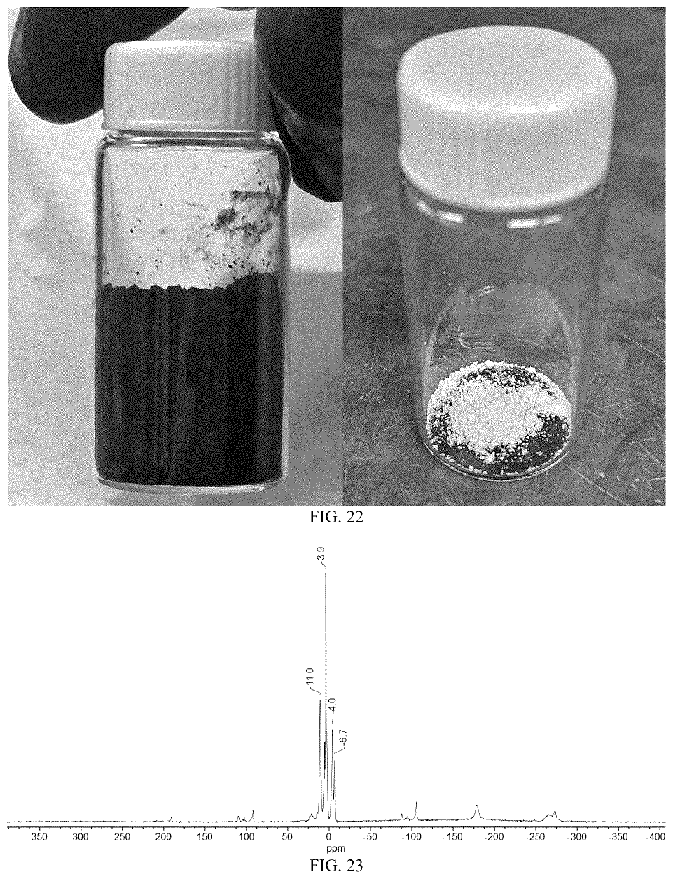

Inside the glovebox, a portion of the crude product acquired from the scale-up experiment of the reduction of Na₃P₃O₉ with K and KI (10% w/w K/KI) (see S.6 for procedure and S.5.4 for the ³¹P solid-state NMR) was filled into a vial. The vial was brought out of the glovebox and opened. The mixture started to change color from black to grey immediately. When taking out a small portion of the mixture out of a vial with a spatula, the discoloration was immediate and resulted in a white powder. After stirring/shaking the solid for several minutes, the complete material turned white (see FIG. 22). The mixture was filled into a 3.2 mm ZrO₂ MAS rotor for the solid-state NMR measurements (FIG. 23).

S.5.4 Reduction of Na₂PO₃F with K and KI

The reaction was performed according to the general procedure (see S.1) with the following parameters: Na₂PO₃F (298 mg, 2.07 mmol), K (162 mg, 4.14 mmol, 2 eq.), KI (1458 mg, 10% K/KI ratio), 450 rpm, 12 h. The crude mixture was filled into a 3.2 mm ZrO₂ MAS rotor inside of a glovebox, and then brought out for the NMR measurements.

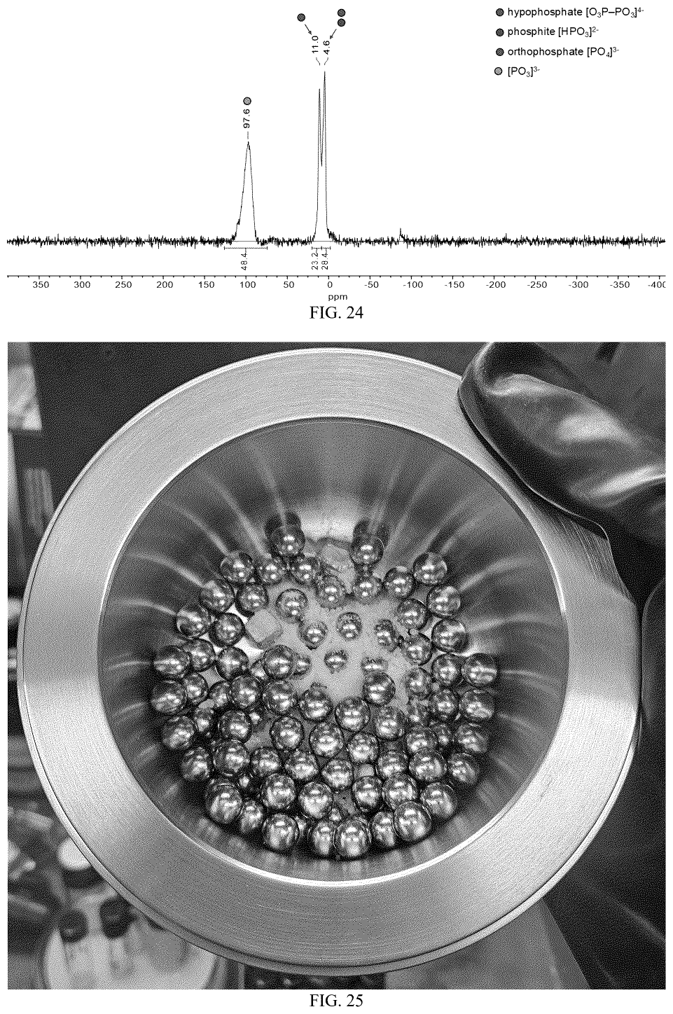

See FIG. 24 for ³¹P solid-state NMR spectrum.

S.6 Scale-up of the PO₃³⁻ Salt Synthesis

The procedure was based on the general procedure (see S.1), but scaled up accordingly (the changed parameters are bold):

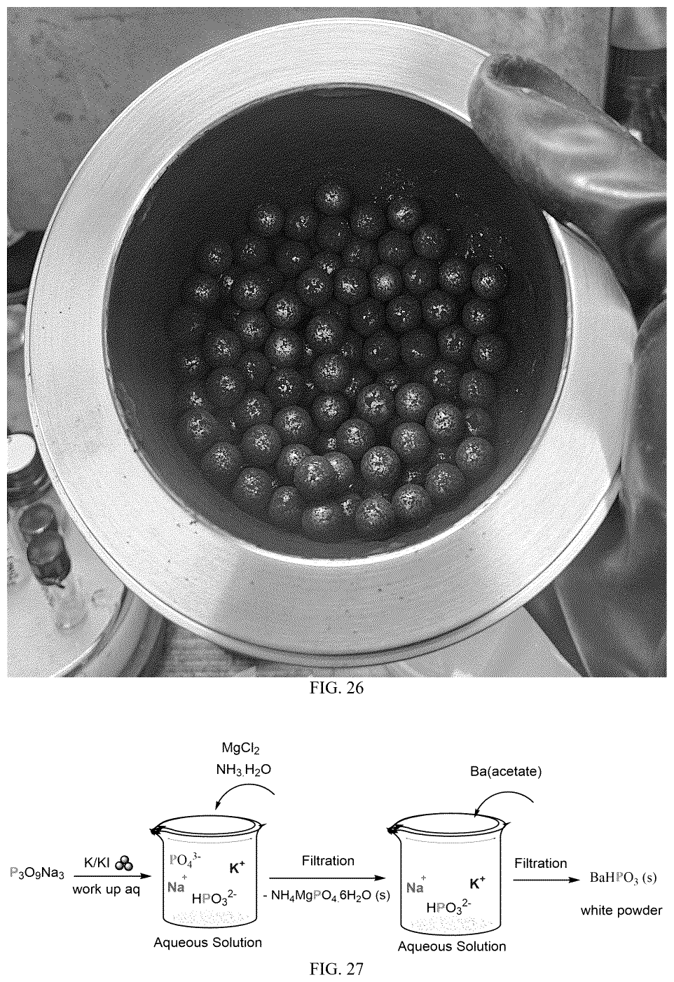

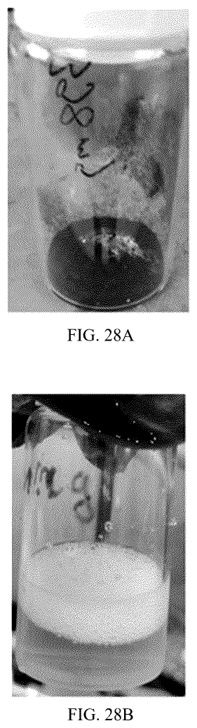

Procedure: Inside the glovebox, Na₃P₃O₉ (1.70 g, 5.56 mmol, 1.00 eq.), potassium (1.30 g, 33.3 mmol, 6.00 eq., four freshly cut chunks), KI (11.7 g) and 100 stainless steel balls (Ø 10 mm) were added into a 500 mL ball-milling jar (FIG. 25). The jar was sealed properly and brought out. The mixture was ball milled at 200 rpm for 5 min, then 450 rpm for 12 h (with cooling breaks of 30 min every 1 h and direction change every cycle, total process time 24 h.). When the desired grinding time was reached, the jar was brought into the glovebox and opened (FIG. 26). The reaction mixture was isolated in a vial (see FIG. 22, left image).

Yield: Theoretically produced crude material: 14.7 g. Isolated crude material: 11.1 g (75%). The composition of the scaled up reaction product does not differ significantly from the original procedure.

S.7 Reactivity of the Crude PO₃³⁻ Salt
S.7.1 Synthesis of Phosphite (HPO₃²⁻) Salts

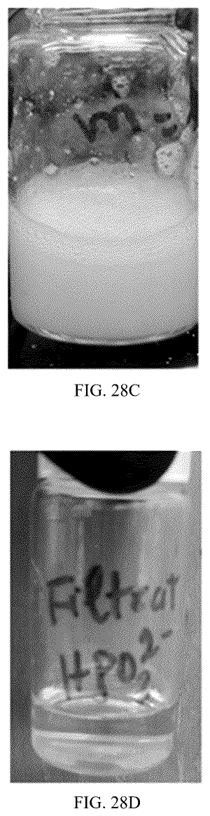

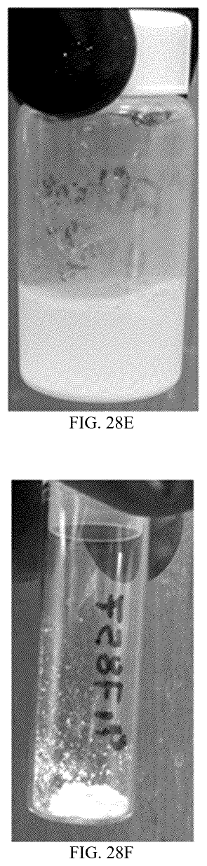

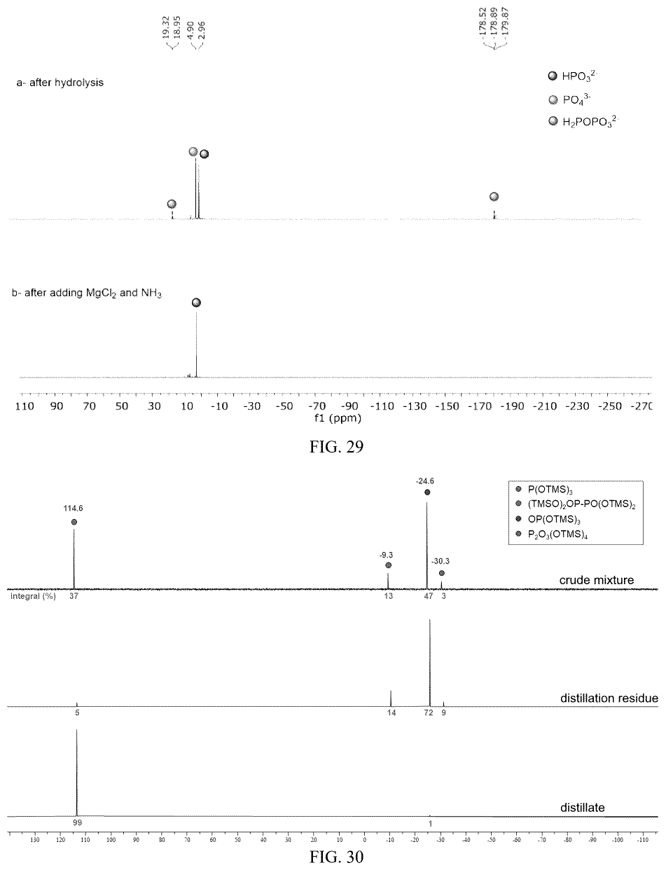

Procedure: The crude mixture containing PO₃³⁻ was hydrolyzed by degassed water under argon. The obtained aqueous solutions were combined. Magnesium chloride (91 mg, 1.3 eq.) and ammonium hydroxide (28% w/w, 0.25 mL, 4.5 eq.) were added, resulting in the rapid formation of a white precipitate, presumably NH₄MgPO₄. The slurry was stirred for 5 min and filtered through filter paper. The removal of all phosphates was confirmed by analyzing an aliquot of the filtrate by ³¹P NMR spectroscopy. Barium acetate (0.3 g, 1.0 eq.) was then added to the filtrate, and the formed barium phosphite (BaHPO₃·H₂O) was collected on a frit (15 mL, medium porosity), transferred to a vial, and dried at 120° C. until a constant mass was achieved, providing BaHPO₃·H₂O (78 mg, 43%). See FIGS. 28-29 for example procedure.

See FIGS. 29A-B for ³¹P {¹H} NMR spectrum after hydrolysis and after adding MgCl₂ and NH₃.

S.7.2 Synthesis of P(OSiMe₃)₃

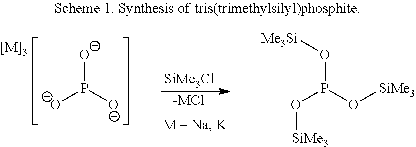

Reaction: Inside the glovebox, the crude ball-milling mixture (3.31 g, containing approximately 1.36 mmol PO₃³⁻, synthesized according to S.3.3) was filled into a 100 mL Schlenk flask and suspended in 35 mL THF. Afterwards, TMSCl (3.50 mL, 27.6 mmol) was added. The suspension was vigorously stirred for 5 h. An aliquot was analyzed by NMR, showing a mixture of P(OTMS)₃ and OP(OTMS)₃. See FIG. 30. The suspension was filtered through celite, and volatiles were removed from the filtrate.

Distillation workup: The crude product was distilled at 1000 mTorr (1.33 mbar). The oil bath was set to 55° C. After several minutes, the distillation head temperature reached 30° C., which resulted in transfer of a colorless liquid. After the distillation head temperature started to decrease again, the distillation was stopped immediately. The receiving vial was brought back into the glovebox. The purified product was isolated by first pipetting it into a vial and then flushing out the rest with THF. Afterwards, the THF was removed again in vacuo. Yield: 162 mg (0.543 mmol, approximately 40%)

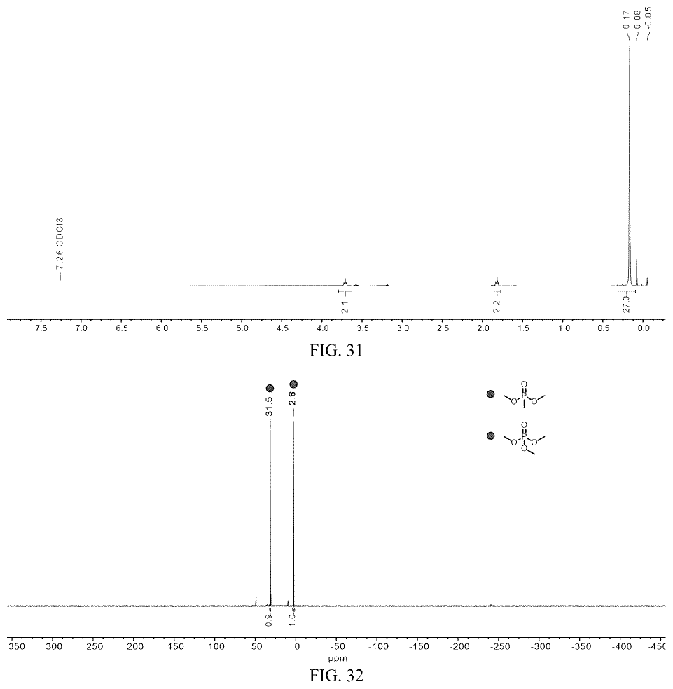

See FIG. 31 for ¹H NMR of distillate.

### S.8 Preliminary Reactivity Studies

### S.8.1 Synthesis of Dimethyl Methylphosphonate (DMMP)

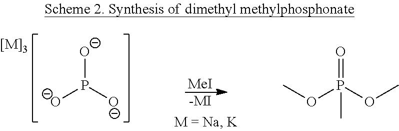

Methylation of the crude mixture containing PO₃³⁻ gave dimethyl methylphosphonate (DMMP), which is used as a flame-retardant. [4,5] It was obtained in 20% ³¹P NMR-yield in a mixture with trimethyl phosphate and was not isolated.

Reaction: Inside the glovebox, the crude ball-milling mixture (100 mg, containing approximately 0.0516 mmol PO₃³⁻, synthesized according to S.3.3) was filled into a young-type NMR tube. Afterwards, C₆D₆ (0.4 mL) and an excess of methyl iodide (0.1 mL) were added, and the NMR tube was tightly closed with a Teflon screw cap. The NMR tube was taken out of the glovebox and then heated at 150° C. for three hours. Afterwards, the NMR tube was cooled down to room temperature and analyzed via ³¹P {¹H} NMR spectroscopy (FIG. 32). The product was not isolated.

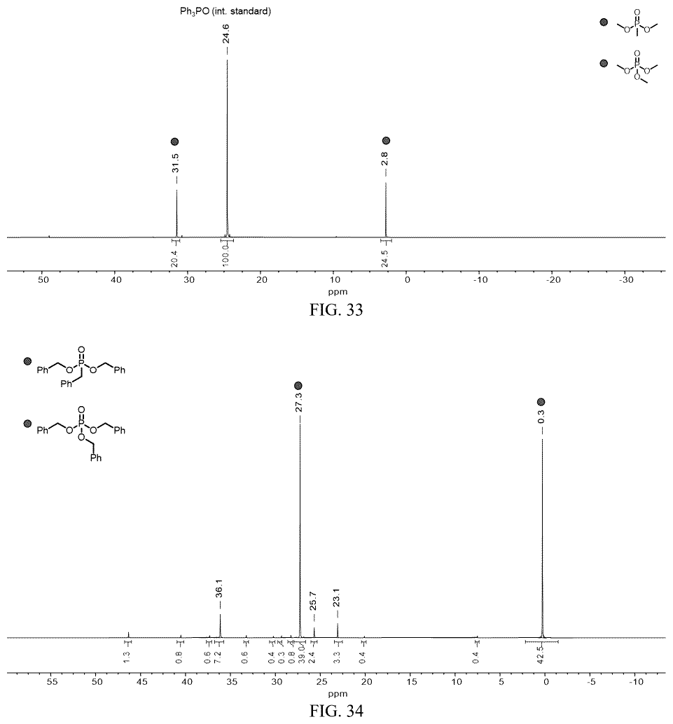

Yield determination: The NMR tube was brought back into the glovebox. Ph₃PO (13.9 mg, 0.0499 mmol) was added as internal standard. The NMR tube was taken out again and analyzed via quantitative ³¹P {¹H} NMR spectroscopy (FIG. 33). Calculated yield: 0.0101 mmol, approximately 20%.

### S.8.2 Synthesis of Dibenzyl Benzylphosphonate (DBBP)

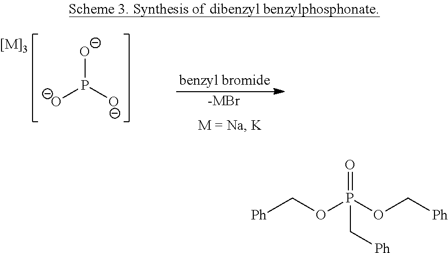

Reaction of PO₃³⁻ with benzyl bromide gave the corresponding phosphonate dibenzyl benzylphosphonate (DBBP) in 22% ³¹P NMR yield and was not isolated.

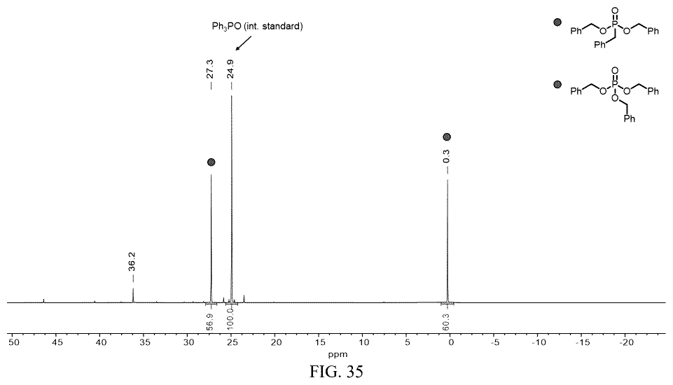

Reaction: Inside the glovebox, the crude ball-milling mixture (500 mg, containing approximately 0.255 mmol PO₃³⁻, synthesized according to S.3.3) was filled into 50 mL Schlenk flask. Afterwards, an excess of benzyl bromide (1.00 mL) as added, and the flask was tightly closed. The flask was taken out of the glovebox and then heated at 60° C. for two days. Optically, no change was detected. Therefore, the flask was heated at 100° C. for additional three days, after which the suspension turned from black to grey. Afterwards, the flask was allowed to cool down to room temperature. All volatiles were removed in vacuo and the flask was brought back into the glovebox. The remaining green/gray solid was extracted with THF (1 mL) and all volatiles were removed again in vacuo. The entire sample was dissolved in C₆D₆ and analyzed via ³¹P {¹H} NMR spectroscopy (FIG. 34).

Yield determination: Inside the glovebox, Ph₃PO (27.8 mg, 0.100 mmol) was added to the sample as internal standard. The mixture was analyzed via quantitative ³¹P {¹H} NMR spectroscopy (FIG. 35). The NMR tube was gently heated to facilitate dissolution. The solution exhibited an almost imperceptible turbidity, which was considered negligible. Calculated yield: 0.0570 mmol, approximately 22%.

### REFERENCES

[1] a) C. M. Sevrain, M. Berchel, H. Couthon, P.-A. Jaffrès, Beilstein J. Org. Chem. 2017, 13, 2186;
b) V. M. M. Achary, B. Ram, M. Manna, D. Datta, A. Bhatt, M. K. Reddy, P. K. Agrawal, Plant Biotechnol. J. 2017, 15, 1493;
c) G. M. Dill, R. D. Sammons, P. C. C. Feng, F. Kohn, K. Kretzmer, A. Mehrsheikh, M. Bleeke, J. L. Honegger, D. Farmer, D. Wright et al. in Glyphosate Resistance in Crops and Weeds: History, Development, and Management (Ed.: E. K. Nandula), John Wiley & Sons, 2010, pp. 1-33;
d) H. Y. Asl, K. Ghosh, M. P. Vidal Meza, A. Choudhury, J. Mater. Chem. A 2015, 3, 7488;
e) Z. Ma, L. Lander, S.-I. Nishimura, M. Okubo, A. Yamada, Chem. Commun. 2019, 55, 14155;
f) H. Yaghoobnejad Asl, A. Choudhury, Inorg. Chem. 2015, 54, 6566.
[2] H. Diskowski, T. Hofmann in Ullmann's encyclopedia of industrial chemistry, Wiley-VCH, Weinheim, 2003.
[3] Jupp, A. R.; Beijer, S.; Narain, G. C.; Schipper, W.; Slootweg, J. C. Phosphorus recovery and recycling—closing the loop. Chem. Soc. Rev. 2021, 50, 87-101.
[4] Nicholls, J. W. F.; Chin, J. P.; Williams, T. A.; Lenton, T. M.; O'Flaherty, V.; McGrath, J. W. On the potential roles of phosphorus in the early evolution of energy metabolism. Frontiers in Microbiology 2023, 14.
[5] Fernández-García, C.; Coggins, A. J.; Powner, M. W. A Chemist's Perspective on the Role of Phosphorus at the Origins of Life. Life 2017, 7.
[6] Blumenfeld, L. A. The physical aspects of energy transduction in biological systems. Quarterly Reviews of Biophysics 1978, 11, 251-308.
[7] von Jagow, G.; Engel, W. D. Structure and Function of the Energy-Converting System of Mitochondria. Angewandte Chemie International Edition in English 1980, 19, 659-675.
[8] Pasek, M. A.; Sampson, J. M.; Atlas, Z. Redox chemistry in the phosphorus biogeochemical cycle. Proceedings of the National Academy of Sciences 2014, 111, 15468-15473.
[9] Achary, V. M. M.; Ram, B.; Manna, M.; Datta, D.; Bhatt, A.; Reddy, M. K.; Agrawal, P. K. Phosphite: a novel P fertilizer for weed management and pathogen control. Plant Biotechnology Journal 2017, 15, 1493-1508.
[10] Galán Mascarós, J. R.; Martí-Gastaldo, C. Supramolecular stabilization of the phosphite-based polyoxomolybdate [Mo6(PO3)(HPO3)3O18]9—. Polyhedron 2007, 26, 626-630.
[11] Kortz, U.; Vaissermann, J.; Thouvenot, R.; Gouzerh, P. Heteropolymolybdates of Phosphate, Phosphonate, and Phosphite Functionalized by Glycine. Inorganic Chemistry 2003,42, 1135-1139.
[12] Greenwood, N., Earnshaw, A., Eds. Chemistry of the Elements, 2nd ed.; Butterworth-Heinemann: Oxford, 1997; pp 547-599.
[13] Emmerling, F.; Röhr, C. Alkaline metal oxoantimonates(III), A₃[SbO₃](A=K or Cs). Acta Crystallographica Section C 2001, 57, 1127-1128.
[14] Emmerling, F.; Zimper, S.; Röhr, C. New Barium Oxoantimonates(III): Synthesis and Crystal Structures of Ba₃[SbO₃]₂ and Ba₂[Sb₂O₅]. Zeitschrift für Naturforschung B 2004, 59, 503-512.
[15] Ghose, S.; Boving, P.; LaChapelle, W. A.; Wan, C. Reinerite, Zn₃(AsO₃)₂; an arsenite with a novel type of Zn-tetrahedral double chain. Amer. Mineral. 1977, 62, 1129-1134.
[16] Velencoso, M. M.; Battig, A.; Markwart, J. C.; Schartel, B.; Wurm, F. R. Molecular Firefighting-How Modern Phosphorus Chemistry Can Help Solve the Challenge of Flame Retardancy. Angewandte Chemie International Edition 2018, 57, 10450-10467.
[17] Weeks Jr., J. J.; Hettiarachchi, G. M. A Review of the Latestbin Phosphorus Fertilizer Technology: Possibilities and Pragmatism.b Journal of Environmental Quality 2019, 48, 1300-1313.
[18] Gulbrandsen, R. Chemical composition of phosphorites of the Phosphoria Formation. Geochimica et Cosmochimica Acta 1966, 30, 769-778.
[19] Emsley, J. The shocking history of phosphorus: A biography of the devil's element; Pan Books, 2001.
[20] Emsley, J. The 13th element: The sordid tale of murder, fire and Phosphorus; Wiley, 2002.
[21] Geeson, M. B.; Cummins, C. C. Phosphoric acid as a precursor to chemicals traditionally synthesized from white phosphorus. Science 2018, 359, 1383-1385.
[22] Geeson, M. B.; Rios, P.; Transue, W. J.; Cummins, C. C. Orthophosphate and Sulfate Utilization for C-E (E=P, S) Bond Formation via Trichlorosilyl Phosphide and Sulfide Anions. Journal of the American Chemical Society 2019, 141, 6375-6384.
[23] Geeson, M. B.; Tanaka, K.; Taakili, R.; Benhida, R.; Cummins, C. C. Photochemical Alkene Hydrophosphination with Bis(trichlorosilyl)phosphine. Journal of the American Chemical Society 2022, 144, 14452-14457.
[24] Zhai, F.; Xin, T.; Geeson, M. B.; Cummins, C. C. Sustainable Production of Reduced Phosphorus Compounds: Mechanochemical Hydride Phosphorylation Using Condensed Phosphates as a Route to Phosphite. ACS Central Science 2022, 8, 332-339.
[25] Chiu, C.-W. Reducing the P-Cycle by Grinding. ACS Central Science 2022, 8, 303-305.
[26] Xin, T.; Cummins, C. C. Mechanochemical Phosphorylation of Acetylides Using Condensed Phosphates: A Sustainable Route to Alkynyl Phosphonates. ACS Central Science 2023, 9, 1575-1580.
[27] Luo, H.; Li, M.; Wang, X.-C.; Quan, Z.-J. Direct synthesis of phosphorotrithioates from [TBA][P(SiCl₃)₂] and disulfides. Org. Biomol. Chem. 2023, 21, 2499-2503.
[28] Xu, W.-B.; Li, M.; Chai, Y.; Tian, Y.-L.; Wang, X.-C.; Quan, Z.-J. Mild and Catalyst-Free Phosphination of Isocyanates with [TBA][P(SiCl₃)₂] for the Synthesis of Phosphinecarboxamides. Asian Journal of Organic Chemistry 2024, 13, e202400178.
[29] Yang, B.; Wang, X.; Chai, Y.; Xu, W.-B.; Tian, Y.-L.; Ma, Y.-J.; Alduma, A. I.; Cao, X.-R.; Wang, X.-C.; Chen, D.-P.; Quan, Z.-J. Direct Synthesis of N-Substituted Phosphinecarboxamides from [TBA][P(SiCl₃)₂] and Isonitriles. Synlett 2024,
[30] Wu, X.; Tian, Y.; Liu, T.; Xu, W.; Liu, H.; Chai, Y.; Wang, Z.; Wang, X.-C.; Quan, Z.-J. Direct and rapid synthesis of arylphosphines (PIII) by oxalyl chloride promoted reduction of inorganic phosphorus salts [TBA][H₂PO₄] with trichlorosilane and palladium catalysis. Research Square 2023.
[31] Hicks, J.; Juckel, M.; Paparo, A.; Dange, D.; Jones, C. Multigram Syntheses of Magnesium(I) Compounds Using Alkali Metal Halide Supported Alkali Metals as Dispersible Reducing Agents. Organometallics 2018, 37, 4810-4813.
[32] Mondal, R.; Yuvaraj, K.; Rajeshkumar, T.; Maron, L.; Jones, C. Reductive activation of N2 using a calcium/potassium bimetallic system supported by an extremely bulky diamide ligand. Chem. Commun. 2022, 58, 12665-12668.
[33] Mondal, R.; Evans, M. J.; Rajeshkumar, T.; Maron, L.; Jones, C. Coordination and Activation of N2 at Low-Valent Magnesium using a Heterobimetallic Approach: Synthesis and Reactivity of a Masked Dimagnesium Diradical. Angewandte Chemie International Edition 2023, 62, e202308347.
[34] Mondal, R.; Evans, M. J.; Nguyen, D. T.; Rajeshkumar, T.; Maron, L.; Jones, C. Steric control of Mg—Mg bond formation vs. N2 activation in the reduction of bulky magnesium diamide complexes. Chem. Commun. 2024, 60, 1016-1019.
[35] Mai, J.; Morasch, M.; Jędrzkiewicz, D.; Langer, J.; Rosch, B.; Harder, S. Alkaline-Earth Metal Mediated Benzene-to-Biphenyl Coupling. Angewandte Chemie International Edition 2023, 62, e202212463.
[36]Jędrzkiewicz, D.; Mai, J.; Langer, J.; Mathe, Z.; Patel, N.; De-Beer, S.; Harder, S. Access to a Labile Monomeric Magnesium Radical by Ball-Milling. Angewandte Chemie International Edition 2022, 61, e202200511.
[37]Jędrzkiewicz, D.; Langer, J.; Harder, S. Low-valent Mg(I) complexes by ball-milling. Zeitschrift für anorganische und allgemeine Chemie 2022, 648, e202200138.
[38] Diskowski, H.; Hofmann, T. Ullmann's Encyclopedia of Industrial Chemistry; John Wiley Sons, Ltd, 2000.
[39] Schrödter, K.; Bettermann, G.; Staffel, T.; Wahl, F.; Klein, T.; Hofmann, T. Ullmann's Encyclopedia of Industrial Chemistry; John Wiley Sons, Ltd, 2008.
[40] Yoza, N.; Ueda, N.; Nakashima, S. pH-dependence of ³¹P-NMR spectroscopic parameters of monofluorophosphate, phosphate, hypophosphate, phosphonate, phosphinate and their dimers and trimers. Fresenius' Journal of Analytical Chemistry 1994, 348, 633-638.
[41] Callis, C. F.; VanWazer, J. R.; Shoolery, J. N.; Anderson, W. A. Principles of Phosphorus Chemistry. III. Structure Proofs by Nuclear Magnetic Resonance1. Journal of the American Chemical Society 1957, 79, 2719-2726.
[42] Magiera, D.; Omelanczuk, J.; Dziuba, K.; Pietrusiewicz, K. M.; Duddeck, H. Phosphine-Rh2[(R)-MTPA]4 Adducts in Solution: Characterization by NMR Spectroscopy and Chiral Discrimination. Organometallics 2003, 22, 2464-2471.
[43] Chojnowski, J.; Cypryk, M.; Michalski, J. The mechanism of the reaction of organic phosphites with trialkylsilyl iodide. Iodoanhydrides of PIII, acids as intermediates. Journal of Organometallic Chemistry 1981, 215, 355-365.
[44] Yaghoobnejad Asl, H.; Choudhury, A. Phosphite as Polyanion Based Cathode for Li-Ion Battery: Synthesis, Structure, and Electrochemistry of LiFe(HPO₃)₂. Inorganic Chemistry 2015, 54, 6566-6572.
[45] Asl, H. Y.; Ghosh, K.; Vidal Meza, M. P.; Choudhury, A. Li₃Fe₂(HPO₃)₃Cl: an electroactive iron phosphite as a new polyanionic cathode material for Li-ion battery. J. Mater. Chem. A 2015, 3, 7488-7497.
[46] Ma, Z.; Lander, L.; Nishimura, S.-i.; Okubo, M.; Yamada, A. HPO₃²⁻ as a building unit for sodium-ion battery cathodes: 3.1V operation of Na₂₋ₓFe(HPO₃)₂(0<x<1). Chem. Commun. 2019, 55, 14155-14157.
[47] Rickard, D. A. Review of phosphorus acid and its salts as fertilizer materials. Journal of Plant Nutrition 2000, 23, 161-180.
[48] Havlin, J. L.; Schlegel, A. J. Review of Phosphite as a Plant Nutrient and Fungicide. Soil Systems 2021, 5.
[49] Bittman, R. Encyclopedia of Reagents for Organic Synthesis; John Wiley Sons, Ltd, 2001.
[50] Kownacki, I.; Marciniec, B.; Szubert, K.; Kubicki, M.; Jankowska, M.; Steinberger, H.; Rubinsztajn, S. Tris(triorganosilyl)phosphites—New ligands controlling catalytic activity of Pt(0) complex in curing of silicone rubber. Applied Catalysis A: General 2010, 380, 105-112.
[51] Han, Y.-K.; Yoo, J.; Yim, T. Why is tris(trimethylsilyl)phosphite effective as an additive for high-voltage lithium-ion batteries?J. Mater. Chem. A 2015, 3, 10900-10909.
[52] Colacino, E.; Isoni, V.; Crawford, D.; Garcia, F. Upscaling Mechanochemistry: Challenges and Opportunities for Sustainable Industry. Trends in Chemistry 2021, 3, 335-339.
[53] Reynes, J. F.; Isoni, V.; Garcia, F. Tinkering with Mechanochemical Tools for Scale Up. Angewandte Chemie International Edition 2023, 62, e202300819.
[54] Crawford, D. E.; Miskimmin, C. K.; Cahir, J.; James, S. L. Continuous multi-step synthesis by extrusion—telescoping solvent free reactions for greater efficiency. Chem. Commun. 2017, 53, 13067-13070.
[55] Dong, L.; Li, L.; Chen, H.; Cao, Y.; Lei, H. Mechanochemistry: Fundamental Principles and Applications. Advanced Science 2024, 2403949.
[56] Pangborn, A. B.; Giardello, M. A.; Grubbs, R. H.; Rosen, R. K.; Timmers, F. J. Safe and Convenient Procedure for Solvent Purification. Organometallics 1996, 15, 1518-1520.
[57] Williams, D. B. G.; Lawton, M. Drying of Organic Solvents: Quantitative Evaluation of the Efficiency of Several Desiccants. J. Org. Chem. 2010, 75, 8351-8354.
[58] Fulmer, G. R.; Miller, A. J. M.; Sherden, N. H.; Gottlieb, H. E.; Nudelman, A.; Stoltz, B. M.; Bercaw, J. E.; Goldberg, K. I. NMR Chemical Shifts of Trace Impurities: Common Laboratory Solvents, Organics, and Gases in Deuterated Solvents Relevant to the Organometallic Chemist. Organometallics 2010, 29, 2176-2179.
[59] Xiang, H.; Xu, H.; Wang, Z.; Chen, C. Dimethyl methylphosphonate (DMMP) as an efficient flame retardant additive for the lithium-ion battery electrolytes. Journal of Power Sources 2007, 173, 562-564.
[60] Velencoso, M. M.; Battig, A.; Markwart, J. C.; Schartel, B.; Wurm, F. R. Molecular Firefighting-How Modern Phosphorus Chemistry Can Help Solve the Challenge of Flame Retardancy. Angewandte Chemie International Edition 2018, 57, 10450-10467.

### Embodiments

1. A method comprising
a) combining phosphate sodium trimetaphosphate with a reducing agent to produce a crude mixture;
b) ball-milling the crude mixture to produce a powder comprising tribasic phosphite and orthophosphate;
c) adding trimethylsilyl chloride to the powder to produce tris(trimethylsilyl)phosphite; or
d) adding water to the powder to produce a phosphite salt.

2. The method of Embodiment 1, further comprising separating the orthophosphate byproduct from the phosphite salt.

3. The method of Embodiment 1 or 2, further comprising distilling the reaction product to purify the phosphite salt.

4. The method of any one of Embodiments 1-3, wherein the reducing agent comprises potassium.

5. The method of any one of Embodiments 1-4, wherein the reducing agent comprises a mixture of potassium and potassium iodide.

6. The method of any one of Embodiments 1-5, wherein the mixture of potassium and potassium iodide is pre-ground before combining with phosphate sodium trimetaphosphate.

7. The method of any one of Embodiments 1-6, wherein the ball-milling is performed for 8, 10, 12, 14, or more hours.

8. The method of any one of Embodiments 1-7, wherein the ball-milling is performed in a steel container.

9. The method of any one of Embodiments 1-8, wherein the phosphate sodium trimetaphosphate comprises a mixture of linear condensed phosphates and cyclic condensed phosphates.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A compound comprising PO₃³⁻ (ortho-phosphite), wherein the PO₃³⁻ is not bound to a transition metal ion.

2. The compound of claim 1, consisting of PO₃³⁻ (ortho-phosphite).

3. A composition comprising the compound of claim 1.

4. A method of making a compound comprising PO₃³⁻ (ortho-phosphite), the method comprising:
a) combining a phosphate with i) a reducing agent or ii) a reducing agent and a dispersant, to produce a mixture; and
b) mechanically processing the mixture to produce the compound comprising the ortho-phosphite.

5. A method of making a silyl phosphite, the method comprising combining a silylating agent with a compound comprising PO₃³⁻ (ortho-phosphite) to produce the silyl phosphite.

6. The method of claim 5, further comprising isolating the silyl phosphite.

7. The method of claim 6, wherein the isolating comprises using vacuum distillation.

8. The method of claim 5, wherein the silyl phosphite is tris(trimethylsilyl)phosphite (TTSP).

9. The method of claim 4, wherein the reducing agent comprises sodium or potassium.

10. The method of claim 4, wherein the dispersant comprises sodium chloride or potassium iodide.

11. The method of claim 4, wherein the phosphate is combined with the reducing agent and the dispersant to produce the mixture, and wherein the weight ratio of the reducing agent to the dispersant is about 1:9.

12. The method of claim 4, wherein the mechanically processing is performed using ball bearings of a diameter of about 10 mm.

13. The method of claim 4, wherein the mechanically processing is performed for from about 1 to about 24 hours.

14. The method of claim 13, wherein the mechanically processing is performed for about 12 hours.

15. The method of claim 4, wherein the mechanically processing is performed in a steel container.

16. The method of claim 4, wherein the phosphate comprises a linear condensed phosphate, a cyclic condensed phosphate, a halogenated phosphate, or a combination thereof.

17. The method of claim 16, wherein the phosphate is Na₃P₃O₉, Na₅P₃O₁₀, (KPO₃)_{∞}, or Na₂PO₃F.

18. (canceled)

19. The method of claim 5, wherein the silylating agent is a silyl halide, trialkoxysilane, or a silyl ester.

20. The method of claim 5, wherein the silylating agent is trimethylsilyl chloride.

21. The method of claim 4, wherein the compound consists of PO₃³⁻ (ortho-phosphite).
